(19) United States
(12) Patent Application Publication
(10) Pub. No.: US 2025/0306729 A1
(43) Pub. Date: Oct. 2, 2025

(54) PORTABLE ELECTRONIC DEVICE FOR PROVIDING APPLICATION-RELATED INFORMATION

(71) Applicant: Samsung Electronics Co., Ltd., Suwon-si (KR)

(72) Inventors: Eunhye JEE, Suwon-si (KR); Yeunwook LIM, Suwon-si (KR); Bona LEE, Suwon-si (KR)

(21) Appl. No.: 19/236,405

(22) Filed: Jun. 12, 2025

Related U.S. Application Data
(63) Continuation of application No. PCT/KR2024/003829, filed on Mar. 27, 2024.

(30) Foreign Application Priority Data
Mar. 29, 2023 (KR) 10-2023-0041200
Apr. 25, 2023 (KR) 10-2023-0053728

(51) Int. Cl. G06F 3/04817; G06F 3/0482; G06F 3/0488; G06F 9/451; H04L 51/224; H04W 4/80

(52) U.S. Cl. CPC G06F 3/04817; G06F 3/0482; G06F 3/0488; G06F 9/452; H04L 51/224; H04W 4/80

(57) ABSTRACT

A portable electronic device is provided. The portable electronic device includes a touch-sensitive display, a wireless communication circuit, memory, comprising one or more storage media, storing instructions, and at least one processor operatively connected to the touch-sensitive display, the wireless communication circuit, and the memory, wherein the instructions, when executed by the at least one processor individually or collectively, cause the portable electronic device to generate a first frame by synthesizing a task bar and an execution screen of a first application, and display the first frame on the touch-sensitive display, acquire a message associated with a second application through the wireless communication circuit, configure notification information associated with the acquired message to be smaller than a size of the execution screen of the first application, and determine the notification information as a first layer, determine the execution screen of the first application as a second layer having a lower priority of display than the first layer, generate a second frame by synthesizing the notification information determined as the first layer and the execution screen of the first application determined as the second layer together with the task bar, and display the second frame on the touch-sensitive display, and based on a user input regarding the notification information being received through the touch-sensitive display, and an icon corresponding to the second application being configured to be provided through the task bar, determine the execution screen of the second application as the first layer and configure the execution screen of the second application to be smaller than the size of the execution screen of the first application, and generate a third frame by synthesizing the execution screen of the second application determined the first layer and the execution screen of the first application determined as the second layer together with the task bar, and display the third frame on the touch-sensitive display.

### CROSS-REFERENCE TO RELATED APPLICATION(S)

This application is a continuation application, claiming priority under 35 U.S.C. § 365(c), of an International application No. PCT/KR2024/003829, filed on Mar. 27, 2024, which is based on and claims the benefit of a Korean patent application number 10-2023-0041200, filed on Mar. 29, 2023, in the Korean Intellectual Property Office, and of a Korean patent application number 10-2023-0053728, filed on Apr. 25, 2023, in the Korean Intellectual Property Office, the disclosure of each of which is incorporated by reference herein in its entirety.

### BACKGROUND

### 1. Field

The disclosure relates to a portable electronic device for providing application-related information.

### 2. Description of Related Art

A portable electronic device (e.g., a smartphone) may receive messages (e.g., push notifications) related to installed applications from an external device through a wireless communication circuit. The portable electronic device may inform the user that a message has been received through pop-up window, for example.

The above information is presented as background information only to assist with an understanding of the disclosure. No determination has been made, and no assertion is made, to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a portable electronic device for providing a user experience (UX) environment for seamless interactions between applications and users through messages.

Additional aspects will be set forth in part in the description which follows and, in part, will be apparent from the description, or may be learned by practice of the presented embodiments.

In accordance with an aspect of the disclosure, a portable electronic device is provided. The portable electronic device includes a touch-sensitive display, a wireless communication circuit, memory, comprising one or more storage media, storing instructions, and at least one processor operatively connected to the touch-sensitive display, the wireless communication circuit and the memory, wherein the instructions, when executed by the at least one processor individually or collectively, cause the portable electronic device to generate a first frame by synthesizing a task bar and an execution screen of a first application, and display the first frame on the touch-sensitive display, acquire a message associated with a second application through the wireless communication circuit, configure notification information associated with the acquired message to be smaller than a size of the execution screen of the first application and determine the notification information as a first layer, determine the execution screen of the first application as a second layer having a lower priority of display than the first layer, generate a second frame by synthesizing the notification information determined as the first layer and the execution screen of the first application determined as the second layer together with the task bar, and display the second frame on the touch-sensitive display, and based on a user input regarding the notification information being received through the touch-sensitive display, and an icon corresponding to the second application being configured to be provided through the task bar, determine the execution screen of the second application as the first layer and configure the execution screen of the second application to be smaller than the size of the execution screen of the first application, and generate a third frame by synthesizing the execution screen of the second application determined as the first layer and the execution screen of the first application determined as the second layer together with the task bar, and display the third frame on the touch-sensitive display.

In accordance with another aspect of the disclosure, a portable electronic device is provided. The portable electronic device includes a touch-sensitive display, a wireless communication circuit, memory, comprising one or more storage media, storing instructions, and at least one processor operatively connected to the touch-sensitive display, the wireless communication circuit, and the memory, wherein the instructions, when executed by the at least one processor individually or collectively, cause the portable electronic device to display a home screen on the touch-sensitive display, acquire notification information associated with an application through the wireless communication circuit, configure the notification information to be smaller than a size of the home screen and determine the notification information as a first layer, determine the home screen as a second layer having a lower priority of display than the first layer, generate a first frame by synthesizing the notification information determined as the first layer and the home screen determined as the second layer, and display the first frame on the touch-sensitive display, and based on a user input regarding the notification information being received through the touch-sensitive display, and an icon corresponding to the application being configured to be provided through the home screen, determine the execution screen of the application as the first layer instead of the notification information, and configure the execution screen of the application to be smaller than the size of the home screen, and generate a second frame by synthesizing the execution screen of the application determined as the first layer and the home screen determined as the second layer, and display the second frame on the touch-sensitive display.

In accordance with another aspect of the disclosure, a portable electronic device is provided. The portable electronic device includes a touch-sensitive display, a wireless communication circuit, memory, comprising one or more storage media, storing instructions at least one processor operatively connected to the touch-sensitive display, the wireless communication circuit, and the memory, wherein the instructions, when executed by the at least one processor individually or collectively, cause the portable electronic device to display a task bar on a first layer or on a second layer having a lower priority of display than the first layer, and display a first execution screen of a first application on the second layer, receive a first user input regarding an icon located on the task bar from the touch-sensitive display, determine an execution screen of a second application corresponding to the icon as the second layer instead of the first execution screen, based on the first user input, configure a second execution screen of a first application to be smaller than a size of the execution screen of the second application, and determine the second execution screen of the first application as the first layer, generate a first frame by synthesizing the second execution screen determined as the first layer and the execution screen of the second application determined as the second layer, and display the first frame on the touch-sensitive display, receive a second user input regarding the second execution screen from the touch-sensitive display, determine a third execution screen of the first application as the first layer instead of the second execution screen, based on the first user input, and configure the third execution screen of the first application to be smaller than the size of the execution screen of the second application, and generate a second frame by synthesizing the third execution screen determined as the first layer and the execution screen of the second application determined as the second layer, and display the second frame on the touch-sensitive display.

In accordance with another aspect of the disclosure, a portable electronic device is provided. The portable electronic device includes a touch-sensitive display, a wireless communication circuit, a processor operatively connected to the display and the wireless communication circuit, and memory operatively connected to the processor. The memory stores instructions which, when executed by the processor, cause the portable electronic device to generate a first frame by synthesizing a task bar and an execution screen of a first application, and display the first frame on the display. The instructions cause the portable electronic device to acquire notification information associated with a second application through the wireless communication circuit. The instructions causes the portable electronic device to configure the notification information to be smaller than the size of the execution screen of the first application and determine the notification information as a first layer. The instructions cause the portable electronic device to determine the execution screen of the first application as a second layer having a lower priority of display than the first layer. The instructions cause the portable electronic device to generate a second frame by synthesizing the notification information determined as the first layer and the execution screen of the first application determined as the second layer together with the task bar, and display the second frame on the display. The instructions cause the portable electronic device to, based on a user input regarding the notification information being received through the display, and an icon corresponding to the second application being configured to be provided through the task bar, determine the execution screen of the second application as the first layer, configure the execution screen of the second application to be smaller than the size of the execution screen of the first application, and generate a third frame by synthesizing the execution screen of the second application determined as the first layer and the execution screen of the first application determined as the second layer together with the task bar, and display the third frame on the display.

In accordance with another aspect of the disclosure, one or more non-transitory computer-readable storage media storing one or more computer programs including computer-executable instructions that, when executed by at least one processor of a portable electronic device individually or collectively, cause the portable electronic device to perform operations are provided. The operations include generating, by the portable electronic device a first frame by synthesizing a task bar and an execution screen of a first application, and display the first frame on a touch-sensitive display, acquiring, by the portable electronic device, a message associated with a second application through a wireless communication circuit, configuring, by the portable electronic device notification information associated with the acquired message to be smaller than a size of the execution screen of the first application and determine the notification information as a first layer, determining, by the portable electronic device, the execution screen of the first application as a second layer having a lower priority of display than the first layer, generating, by the portable electronic device, a second frame by synthesizing the notification information determined as the first layer and the execution screen of the first application determined as the second layer together with the task bar, and display the second frame on the touch-sensitive display, and based on a user input regarding the notification information being received through the touch-sensitive display, and an icon corresponding to the second application being configured to be provided through the task bar, determining, by the portable electronic device, the execution screen of the second application as the first layer, and configure the execution screen of the second application to be smaller than the size of the execution screen of the first application, and generating, by the portable electronic device, a third frame by synthesizing the execution screen of the second application determined as the first layer and the execution screen of the first application determined as the second layer together with the task bar, and display the third frame on the touch-sensitive display.

In accordance with another aspect of the disclosure, a method performed by a portable electronic device with a touch sensitive display is provided. The method includes generating, by the portable electronic device, a first frame by synthesizing a task bar and an execution screen of a first application, and display the first frame on a touch-sensitive display, acquiring, by the portable electronic device, a message associated with a second application through a wireless communication circuit, configuring, by the portable electronic device, notification information associated with the acquired message to be smaller than a size of the execution screen of the first application and determine the notification information as a first layer, determining, by the portable electronic device, the execution screen of the first application as a second layer having a lower priority of display than the first layer, generating, by the portable electronic device, a second frame by synthesizing the notification information determined as the first layer and the execution screen of the first application determined as the second layer together with the task bar, and display the second frame on the touch-sensitive display, and based on a user input regarding the notification information being received through the touch-sensitive display, and an icon corresponding to the second application being configured to be provided through the task bar, determining, by the portable electronic device, the execution screen of the second application as the first layer and configure the execution screen of the second application to be smaller than the size of the execution screen of the first application, and generating, by the portable electronic device, a third frame by synthesizing the execution screen of the second application determined as the first layer and the execution screen of the first application determined as the second layer together with the task bar, and display the third frame on the touch-sensitive display.

According to above-described embodiments, an electronic device provides a user experience (UX) environment for seamless interactions between applications and users through messages.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a portable electronic device configured to provide a UX environment (e.g., a graphical user interface (GUI)) for a seamless interaction between an application and a user, according to an embodiment of the disclosure;

FIGS. 3A, 3B, and 3C are drawings for describing operations for managing a screen, based on notification information and user inputs, in a portable electronic device according to various embodiments of the disclosure;

FIGS. 4A, 4B, and 4C are drawings for describing operations for managing a screen, based on notification information and user inputs, in a portable electronic device according to various embodiments of the disclosure;

FIGS. 5A, 5B, 5C, and 5D are drawings for describing operations for managing a screen, based on notification information and user inputs, in a portable electronic device according to various embodiments of the disclosure;

FIGS. 6A, 6B, and 6C are drawings for describing operations for managing a screen, based on notification information and user inputs, in a portable electronic device according to various embodiments of the disclosure;

FIGS. 7A, 7B, 7C, and 7D are drawings for describing operations for managing a screen, based on user inputs, in a portable electronic device according to various embodiments of the disclosure;

FIGS. 8A, 8B, and 8C are drawings for describing operations for managing a screen, based on user inputs, in a portable electronic device according to various embodiments of the disclosure;

FIGS. 9A, 9B, and 9C are drawings for describing operations for managing a screen, based on user inputs, in a portable electronic device according to various embodiments of the disclosure;

FIG. 10 is a flowchart for describing operations for managing a screen in a portable electronic device according to an embodiment of the disclosure;

FIG. 11 is a flowchart for describing operations of a processor for managing a screen in a portable electronic device according to an embodiment of the disclosure; and

FIG. 12 is a flowchart for describing operations for managing a screen in a portable electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

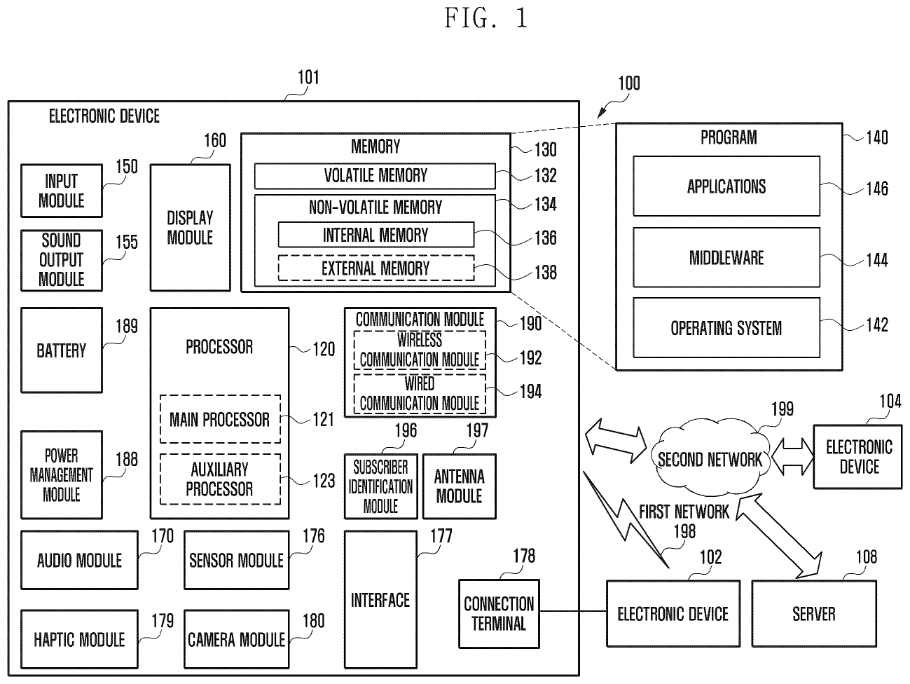

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

A bar-type housing structure may be applied to the electronic device (e.g., a smartphone or a tablet personal computer (PC)) 101. For example, the bar-type housing structure may include a plate (or a cover) configured to form the front surface of the electronic device 101, a plate configured to form the rear surface of the electronic device 101, and a bezel structure configured to form a side surface surrounding the front and rear surfaces. A display may be arranged on the front surface.

A foldable housing structure may be applied to the electronic device (e.g., a smart phone, a tablet PC, or a laptop PC) 101. For example, the electronic device 101 may have a foldable housing structure divided into two housings around a folding axis. The first display area of a display (e.g., a flexible display) may be disposed on the first housing, and the second display area of the display may be disposed on the second housing. The foldable housing structure may be implemented in an in-folding type such that the first display area and the second display area face each other when the electronic device 101 is in a folded state. Alternatively, the foldable housing structure may be implemented in an out-folding type such that the first display area and the second display area face in opposite directions when the electronic device 101 is in a folded state.

A slidable (or rollable) housing structure may be applied to the electronic device (e.g., a smart phone, a tablet PC, or a laptop PC) 101. The electronic device 101 may include a slidable housing including a housing (or a first housing) and a slider (or a second housing), a rail structure (e.g., a rail structure based on gear coupling between a rack gear and a pinion gear) configured such that the slider moved into the housing and moves out of the housing, and a rollable display (e.g., a flexible display). The slider may be divided into a portion which may move into the housing (hereinafter, referred to as an inwardly movable portion) and a portion which remains exposed to the outside. In a slide-out state in which the inwardly movable portion of the slider has fully moved out of the housing (in other words, in a first state, in an open state, in an extended state, or in a roll-out state), the entire display (or the majority of the display area) may be exposed to the outside through the front surface. As the inwardly movable portion of the slider moves into the housing, the display may also move into the housing. The display may be divided into a portion which remains exposed to the outside (e.g., a first display area or a first section) and a portion which may move into the housing (e.g., a second display area, a second section, or a bendable section). In the case of a state transition to a slide-in state in which the inwardly movable portion of the slider has fully moved into the housing (in other words, a second state, a closed state, a reduced state, or a roll-in state), the entire second display area of the display may move into the housing. In an embodiment, in the case of a state transition from the slide-out state to the slide-in state, a part of the display (e.g., the second display area) may be moved to the rear surface through the side surface and disposed thereon, instead of moving into the housing. As exemplified above, the electronic device 101 may have a sliding structure in which a part of the display moves into the housing, or a sliding structure in which a part of the display is moved from the front surface to the rear surface and disposed thereon. Only the portion of the display, which is exposed through the front surface, may be determined to be an activated display area which displays visual information (hereinafter, referred to as an activated area). The portion of the display, which is moved into the housing or moved to the rear surface and disposed thereon may be determined to be an inactive area which displays no visual information.

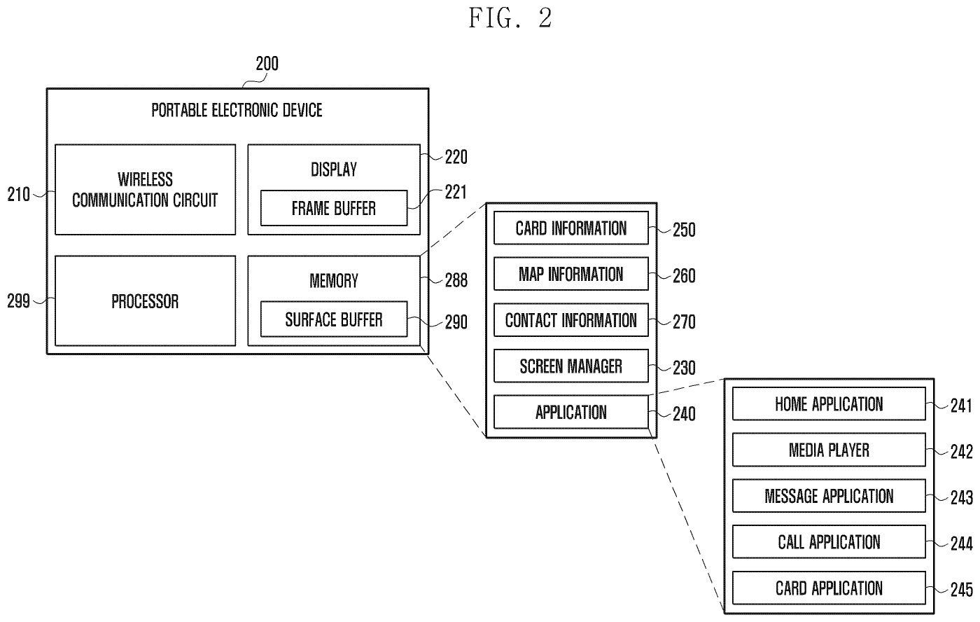

FIG. 2 is a block diagram of a portable electronic device configured to provide a UX environment (e.g., a graphical user interface (GUI)) for a seamless interaction between an application and a user, according to an embodiment of the disclosure.

Referring to FIG. 2, a portable electronic device 200 (e.g., the electronic device 101 in FIG. 1) may include a wireless communication circuit 210, a touch-sensitive display (i.e., display 220), a screen manager 230, an application 240, memory 288, and/or a processor 299. The wireless communication circuit 210, the display 220, the memory 288, and the processor 299 may be implemented substantially identically to the wireless communication module 192, the display module 160, the memory 130, and the processor 120 in FIG. 1, respectively, thereby performing identical functions.

The screen manager 230 (e.g., the middleware 144 or the application 146 in FIG. 1) may be configured to determine the components and layout of a screen to be displayed on the display 220. As an example, the screen manager 230 may divide active areas in which visual information is to be displayed on the display 220 into a first display area (or an upper area), a second display area (a middle area), and a third display area (or a lower area). The screen manager 230 may provide a status bar (in other words, a status display bar) such that the user can recognize the operating status of the portable electronic device 200 through the first display area. The status bar may be configured to include, the time, the network connectivity status, the remaining battery level, and notification icons, for example. The screen manager 230 may provide execution screens (e.g., a home screen, a message screen, a call screen, and a playback screen) for an application 240 through a second display area (e.g., an app window area). The screen manager 230 may provide a navigation bar for navigation between execution screens through a third display area. Processes which reside in volatile memory (e.g., random access memory (RAM)) and which are being executed or standby may be divided into a background process and a foreground process (or a top-layer process and a non-background process). For example, processes corresponding to application execution screens which are displayed on the screen (i.e., display 220) and thus can interact with the user may be classified as foreground processes. Processes which are hierarchically located below the foreground processes and thus are not displayed on the display 220 may be classified as background processes. The navigation bar is a user interface which enables navigation to application execution screens corresponding to background processes, and may be configured by a button for navigating to recently used applications, a button for navigating from other execution screens to the home screen, and a button for navigating to the previous screen. The screen manager 230 may provide a task bar (or a dock bar) through the third display area. The task bar may be configured by application icons corresponding to designated applications (e.g., applications which are frequently executed or selected by the user).

The screen manager 230 and the application 240 may be configured by instructions which may be stored in the memory 288 and executed by the processor 299. The processor 299 may store data which is available when the screen manager 230 and the application 240 are executed, in the memory 288. For example, the processor 299 may store card information 250, map information 260, and contact information 270 in the memory 288 and may allow the screen manager 230 and the application 240 to access the information 250, 260, and 270. The processor 299 may store data (e.g., messages or push notifications received through the wireless communication circuit 210) generated or acquired by execution of the screen manager 230 or other components (e.g., the applications 240) of the portable electronic device 200, in the memory 288.

The application 240 may include a home application 241 configured to provide basic UI elements (e.g., a status bar, a task bar, a navigation bar, and a home screen) for interactions between the user and the portable electronic device 200, a media player 242 configured to support streaming of music or video through the wireless communication circuit 210, a message application 243 configured to support transmission/reception of messages through the wireless communication circuit 210, and a call application 244 configured to support voice calls or video calls through the wireless communication circuit 210. The application 240 may further include a card application 245. The card application 245 may provide various pieces of card company-specific card information 250 (e.g., card numbers, card verification codes (CVCs), expiration dates, and card images) used for online financial services (e.g., payment, Internet banking, and account transfer) or services related to online financing (e.g., membership subscription and discount).

According to an embodiment, the screen manager 230 may display a task bar and a first application execution screen on the first layer (in other words, the foremost side) of the display 220. As used herein, layers may be determined as the priority of display for interactions between the user and the portable electronic device 200. For example, visual information designated as the first layer (the highest layer) may have a higher priority of display than visual information designated as the second layer. Therefore, a part of the visual information designated as the second layer may be covered by the visual information designated as the first layer. Alternatively, the entire visual information designated as the second layer may not be displayed on the display 220 due to the visual information designated as the first layer. The screen manager 230 may recognize that, while the task bar and the first application execution screen are displayed, there is notification information to be provided to the user in relation to a second application (e.g., the media player 242, the message application 243, the call application 244, or the card application 245) corresponding to an icon located on the task bar. As an example, the processor 299 may receive a message from an external device through the wireless communication circuit 210. The screen manager 230 may determine that the message reception is notification information associated with the message application 243. The screen manager 230 may generate notification information, based on the received message. As another example, the wireless communication circuit 210 may include, for example, a GNSS communication circuit as a communication circuit for identifying geographical locations. The processor 299 may recognize the user's location (e.g., a store) by using location data acquired from the GNSS communication circuit. For example, the processor 299 may transmit location data to an external device (e.g., a map service server) (e.g., the server 108 in FIG. 1) through the wireless communication circuit 210. The processor 299 may receive map information (260) corresponding to the location data (e.g., information regarding respective locations of stores within a designated radius around the user's location) from the external device through the wireless communication circuit 210 and may store the same in the memory 288. The processor 299 may acquire information (e.g., store name) regarding the store at which the user is located from the map information 260 stored in the memory 288. The screen manager 230 may determine, based on the recognized location and the time of stay satisfying designated conditions (e.g., in case of recognizing that the user is located at a designated store and has stayed at the store for a designated time or longer), that a card-related message received from the external device through the wireless communication circuit 210 and stored in the memory 288 in association with the card application 245 is notification information to be provided to the user. The screen manager 230 may generate notification information, based on the card-related message. Based on the notification information being recognized, the screen manager 230 may configure the first application execution screen as a surface (in other words, an image) to be displayed on the second layer (or lower layer), may configure notification information to be smaller than the size of the second layer surface (e.g., the first application execution screen), and may configure the same as a surface to be displayed on the first layer (or upper layer). The screen manager 230 may synthesize the first layer surface and the second layer surface into one frame and may display the synthesized frame on the display 220. Accordingly, the user may experience a visual effect such that the notification information (the first layer surface) suddenly appears out of the existing screen (e.g., the first application execution screen configured as the second layer). The screen manager 230 may receive the user's touch input regarding the notification information from the display 220. Based on a touch input being received and an icon corresponding to the second application being configured to be provided through the task bar, the screen manager 230 may configure the second application execution screen as the surface to be displayed on the first layer instead of the notification information. The screen manager 230 may synthesize the second layer surface (the first application execution screen) and the first layer surface (the second application execution screen) into one frame and may display the synthesized frame on the display 220. Accordingly, the user may experience a visual effect such that, while display of the first application execution screen is maintained, the notification information is changed to the second application execution screen.

According to an embodiment, the screen manager 230 may designate a home screen including multiple application icons as a first layer or a second layer and may display the same on the display 220. The screen manager 230 may recognize that, while the home screen is displayed, there is notification information (e.g., a conversation-related message, a card-related message, or a streaming-related message) to be provided to the user in relation to an application (e.g., the media player 242, the message application 243, the call application 244, or the card application 245) corresponding to an icon positioned on the home screen. Based on the notification information being recognized, the screen manager 230 may configure the home screen as a surface to be displayed on the second layer, may configure the notification information to be smaller than the size of the second layer surface, and may configure the same as a surface to be displayed on the first layer. The screen manager 230 may synthesize the first layer surface and the second layer surface into one frame and may display the synthesized frame on the display 220. The screen manager 230 may receive the user's touch input regarding the notification information from the display 220. Based on the touch input being received and the icon corresponding to the application related to the notification information being configured to be provided on the home screen, the screen manager 230 may configure the corresponding application's execution screen as the first layer surface instead of the notification information and may configure the same to be smaller than the size of the home screen. The screen manager 230 may synthesize the home screen (second layer surface) and the application execution screen (first layer surface) into one frame and may display the synthesized frame on the display 220.

According to an embodiment, the screen manager 230 may display the first application execution screen on the second layer. The screen manager 230 may receive the user's touch input regarding an icon located on a task bar designated as the first layer (or the second layer) from the display 220. In response to the touch input, the screen manager 230 may configure the second application execution screen corresponding to the touched icon as the surface to be displayed on the second layer. The screen manager 230 may configure content (e.g., a streaming video or a video call screen) related to the first application to be smaller than the size of the second layer surface and may configure the same as a surface to be displayed on the first layer. The screen manager 230 may synthesize the first layer surface (content) and the second layer surface (second application execution screen) into one frame and may display the synthesized frame on the display 220. Accordingly, the user may experience a visual effect such that objects displayed on the second layer are switched from the first application execution screen to the second application execution screen, and the content related to the first application appears floating on the second application execution screen. The screen manager 230 may display an image related to the floating content (e.g., an image showing a profile regarding a streaming video, or an image showing a profile of the video call counterpart, acquired from the contact information 270) on the task bar, instead of the selected icon. The screen manager 230 may receive the user's touch input regarding the floating content from the display 220. In response to the touch input, the screen manager 230 may configure the first application execution screen (or detailed information of the content) as the first layer surface, instead of the content, and may configure the same to be smaller than the size of the second application execution screen (second layer surface). The screen manager 230 may synthesize the second layer surface (second application execution screen) and the first layer surface (first application execution screen or detailed information of the content) into one frame and may display the synthesized frame on the display 220.

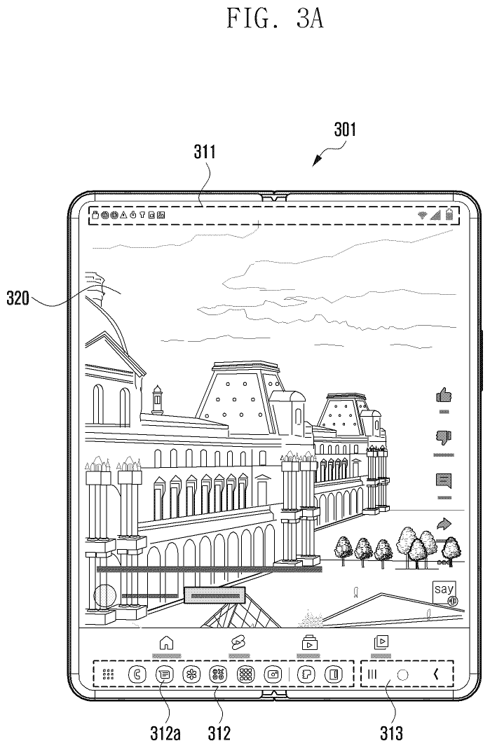

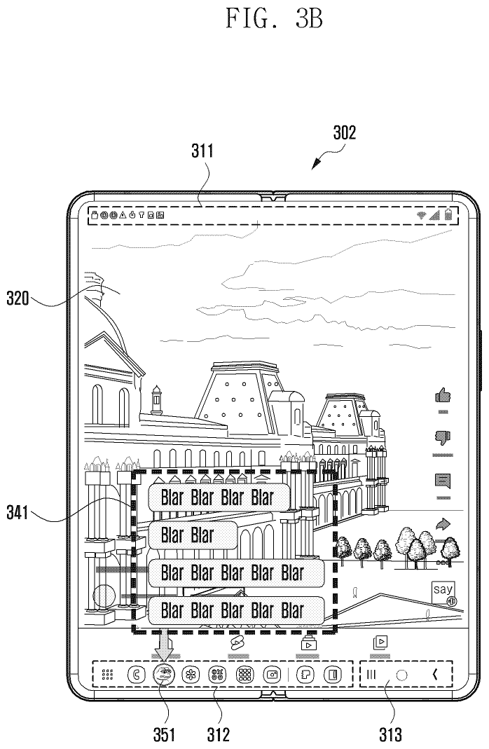

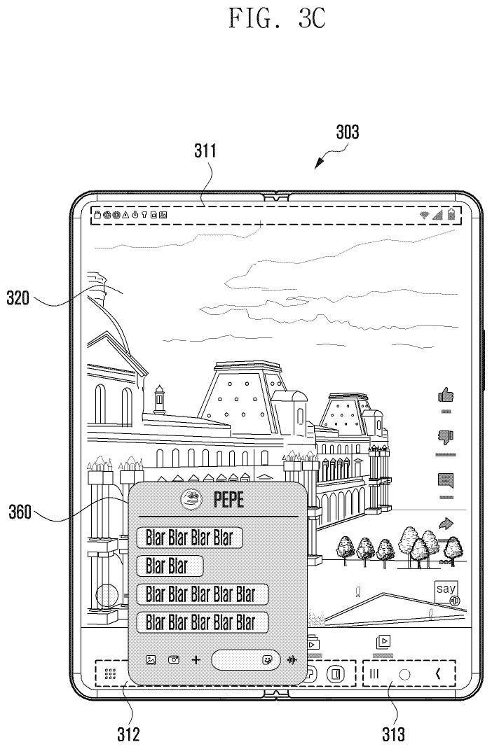

FIGS. 3A, 3B, and 3C are drawings for describing operations for managing a screen, based on notification information and user inputs, in a portable electronic device according to various embodiments of the disclosure.

Referring to FIG. 3A, the application 240 may make multiple surfaces to be displayed on the display 220 and may store the same in the surface buffer 290. For example, the home application 241 may generate a status bar 311, a home screen, a task bar 312, and a navigation bar 313 and may store the same in the surface buffer 290. The media player 242 may generate a playback screen 320 as an execution screen of the media player 242 and may store the same in the surface buffer 290. The surface buffer 290 described above is a depository for storing surfaces generated by the application 240, and a part of the memory 288 (e.g., volatile memory 132) may be allocated as the surface buffer 290. The processor 299 may acquire surfaces to be displayed on the display 220 from the surface buffer 290 and may synthesize the acquired surfaces into one frame. For example, based on the media player 242 being determined as a foreground process, the processor 299 may acquire the status bar 311, the playback screen 320, the task bar 312, and the navigation bar 313 from the surface buffer 290, and may designate the layer and position of each of the acquired surfaces. The processor 299 may designate positions such that surfaces classified as belong to the same layer do not overlap each other. For example, the processor 299 may designate the playback screen 320 as a surface to be displayed on the second layer, and may designate the status bar 311, the task bar 312, and the navigation bar 313 as surfaces to be displayed on the first layer. The processor 299 may designate the display position of the playback screen 320 on the second layer to be the screen center. Alternatively, the processor 299 may configure the entire active area configured to display visual information on the display 220 as the area in which the playback screen 320 is to be displayed. The processor 299 may designate the display position of the status bar 311 on the first layer to be the screen top which is at a distance from the screen center, and may designate the display position of the task bar 312 and the navigation bar 313 on the first layer to be the screen bottom which is at a distance from the screen center. Based on the designation, the processor 299 may synthesize the first layer surface and the second layer surface into a first frame 301 and may write the same in the frame buffer 221. The frame buffer 221 is a depository for storing frames to be displayed on the display 220 and, e.g., memory mounted in the display 220 (e.g., memory in a display driver IC (DDI)) may be allocated as the frame buffer 221. The display 220 may scan the frame buffer 221 so as to acquire and display the first frame 301. The task bar 312 may include an icon 312a corresponding to the message application 243. In the above-described example, the display positions of the status bar 311 and the navigation bar 313 may be the left and right sides of the screen, respectively.

Referring to FIG. 3B, the processor 299 may receive a conversation-related message (i.e., notification information 341) (e.g., a direct message (DM), a short message, a multimedia message, or a chat) from an external device through the wireless communication circuit 210. The processor 299 may recognize the received message as notification information to be visually provided to the user. The processor 299 may generate notification information 341, based on the content of the received message, and may designate the notification information 341 as the first layer surface together with the status bar 311, the task bar 312, and the navigation bar 313 which have previously been classified as the first layer surface. Based on the designation, the processor 299 may synthesize the first layer surface and the second layer surface into a second frame 302 and may write the same in the frame buffer 221. The display 220 may scan the frame buffer 221 so as to acquire and display the second frame 302. The processor 299 may acquire a profile image 351 showing the counterpart who has sent the message from the contact information 270, based on an in icon 312a (refer to FIG. 3A) which shows a message application 243 configured to receive messages being displayed through the task bar 312, and may display the acquired profile image 351 on the task bar 312 instead of the icon 312a. The processor 299 may generate a message box in a rectangular shape having round corners as illustrated in FIG. 3B (which is not limitative, and the message box has the shape of a balloon or cloud, as another example), and may display the notification information 341 on the first layer while being contained in the message box. The processor 299 may receive the user's touch input regarding the notification information 341 displayed on the first layer from the display 220. The processor 299 may display a profile image 351 while the notification information 341 is displayed. In case that no touch input is received within a specified time, thereby ending the display of the message (i.e., notification information 341), the processor 299 may end the display of the profile image 351 and may display the icon 312a again in the corresponding position.

Referring to FIG. 3C, the processor 299 may maintain the layer of the playback screen 320 intact or change the same to a lower layer, based on a touch input regarding notification information 341 displayed on the first layer being received, and an icon 312a corresponding to a message application 243 configured to receive messages being configured to be provided through the task bar 312, may configure a first message screen 360 as an execution screen of the message application 243 to be smaller than the size of the playback screen 320, and may designate the first message screen 360 as a layer (e.g., first layer) higher than the layer designated for the playback screen 320. The processor 299 may designate the status bar 311, the task bar 312, and the navigation bar 313 as a layer higher than the layer designated for the playback screen 320. For example, in case that the first message screen 360 is designated as the first layer, and the playback screen 320 is designated as the third layer, the status bar 311, the task bar 312, and the navigation bar 313 may be designated as the second layer. The processor 299 may synthesize the designated layer surfaces into a third frame 303 and may write the same in the frame buffer 221. The display 220 may scan the frame buffer 221 so as to acquire and display the third frame 303. In case that the display of the message screen 360 is ended, the processor 299 may end the display of the profile image 351.

The message application 243 may not be configured to be provided through the task bar 312, and no icon 312a (FIG. 3A) may accordingly exist on the task bar 312, unlike the above-described embodiment. In such a case, the processor 299 may display the second message screen of the message application 243 instead of the playback screen 320. For example, the processor 299 may designate the media player 242 as a background process and may designate the message application 243 as a foreground process. Based on the designation, the processor 299 may designate the second message screen as a surface to be displayed on the second layer, and may designate the status bar 311, the task bar 312, and the navigation bar 313 as surfaces to be displayed on the first layer. The second message screen may be larger than the first message screen 360 (e.g., may have the same size as the playback screen 320). Based on the designation, the processor 299 may synthesize the first layer surface and the second layer surface into a fourth frame and may write the same in the frame buffer 221. The display 220 may scan the frame buffer 221 so as to acquire and display the fourth frame.

According to an embodiment, the processor 299 may determine the display position of the message screen 360, based on the position in which the corresponding notification information 341 is displayed. For example, the processor 299 may display the message screen 360 at or near the location at which the notification information 341 is displayed. According to an embodiment, the processor 299 may determine the display position of the message screen 360, based on a user input. For example, the processor 299 may receive a touch input from the display 220 as the user's response to the display of the notification information 341. The processor 299 may display the message screen 360 at the location at which the touch input has occurred on the display 220.

In the following descriptions of operations of the processor 299, descriptions identical to those made with reference to FIGS. 3A, 3B, and 3C will be omitted or simplified.

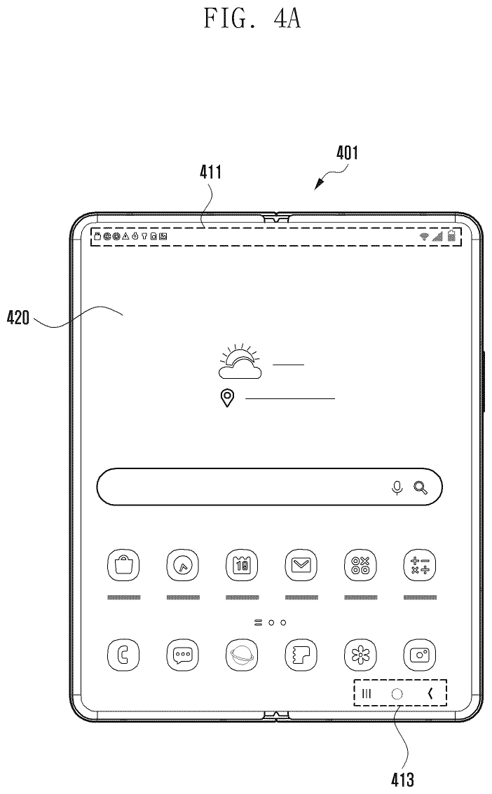

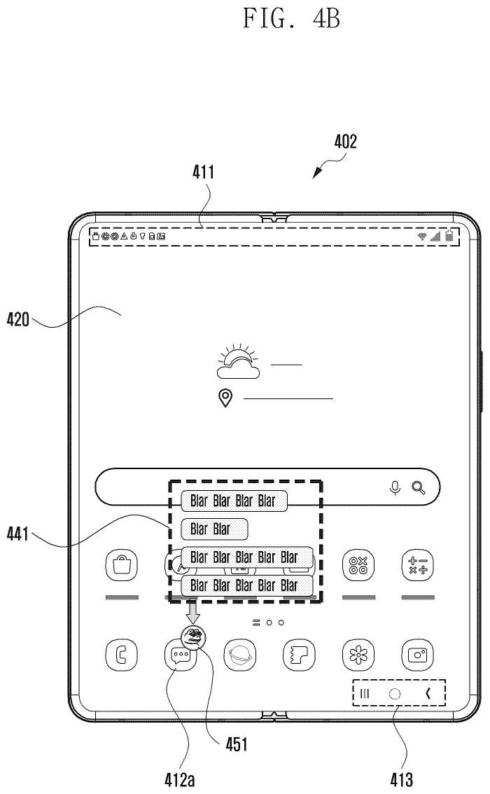

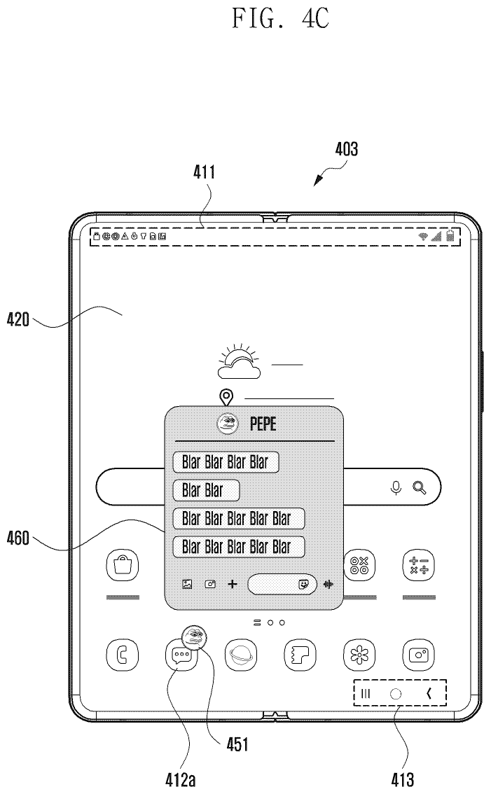

FIGS. 4A, 4B, and 4C are drawings for describing operations for managing a screen, based on notification information and user inputs, in a portable electronic device according to various embodiments of the disclosure.

Referring to FIG. 4A, the home application 241 may generate a status bar 411, a home screen 420, and a navigation bar 413 and may store the same in the surface buffer 290. Based on the home application 241 being determined as a foreground process, the processor 299 may acquire the status bar 411, the home screen 420, and the navigation bar 413 from the surface buffer 290. Based on layout information, the processor 299 may synthesize the acquired surfaces 411, 413, and 420 into a first frame 401. For example, based on layout information acquired from the home application 241, the processor 299 may generate a first frame 401 configured such that the status bar 411 is located at the screen top, the navigation bar 413 is located at the screen bottom, and the home screen 420 is located at the screen center, and may write the same in the frame buffer 221. The display 220 may scan the frame buffer 221 so as to acquire and display the first frame 401.

Referring to FIG. 4B, the processor 299 may receive a conversation-related message from an external device through the wireless communication circuit 210. The processor 299 may recognize the received message as notification information to be visually provided to the user, and may generate notification information 441, based on the content of the message. The processor 299 may designate the notification information 441 as a first layer surface. The processor 299 may designate the home screen 420 as a second layer surface. The processor 299 may designate the status bar 411 as a first layer surface or a second layer surface. The processor 299 may designate the navigation bar 413 as a first layer surface or a second layer surface. Based on the designation, the processor 299 may synthesize the first layer surface and the second layer surface into a second frame 402 and may write the same in the frame buffer 221. The display 220 may scan the frame buffer 221 so as to acquire and display the second frame 402. The processor 299 may acquire a profile image 451 showing the counterpart who has sent the message from the contact information 270, based on an in icon 412a which shows a message application 243 configured to receive messages being displayed through the home screen 420, and may display the acquired profile image 451 so as to be adjacent to the icon 412a (e.g., so as to overlap the icon 412a as illustrated). The processor 299 may receive the user's touch input regarding the notification information 441 displayed on the first layer from the display 220. The processor 299 may display the profile image 451 while the notification information 441 is displayed. In case that no touch input is received within a specified time, thereby ending the display of the notification information 441, the processor 299 may end the display of the profile image 451.

Referring to FIG. 4C, based on a touch input regarding notification information 441 displayed on the first layer being received, and an icon 412a corresponding to a message application 243 configured to receive messages being configured to be provided through the home screen 420, the processor 299 may configure the message screen 460 of the message application 243 to be smaller than the size of the home screen 420, and may designate the message screen 460 as a layer (e.g., first layer) higher than the layer designated for the home screen 420. The processor 299 may designate the status bar 411 and the navigation bar 413 as a layer equal to or higher than the layer designated for the home screen 420. For example, in case that the message screen 460 is designated as the first layer, and the home screen 420 is designated as the second layer, the status bar 411 and the navigation bar 413 may be designated as the first or second layer. The processor 299 may synthesize the designated layer surfaces into a third frame 303 and may write the same in the frame buffer 221. The display 220 may scan the frame buffer 221 so as to acquire and display the third frame 403. The processor 299 may display the profile image 451 while the message screen 460 is displayed. In case that the display of the message screen 460 is ended, the processor 299 may end the display of the profile image 451.

According to an embodiment, the processor 299 may determine the display position of the message screen 460, based on the position in which the corresponding notification information 441 is displayed. For example, the processor 299 may display the message screen 460 at or near the location at which the message 441 is displayed. According to an embodiment, the processor 299 may determine the display position of the message screen 460, based on a user input. For example, the processor 299 may receive a touch input from the display 220 as the user's response to the display of the notification information 441. The processor 299 may display the message screen 460 at the location at which the touch input has occurred on the display 220.

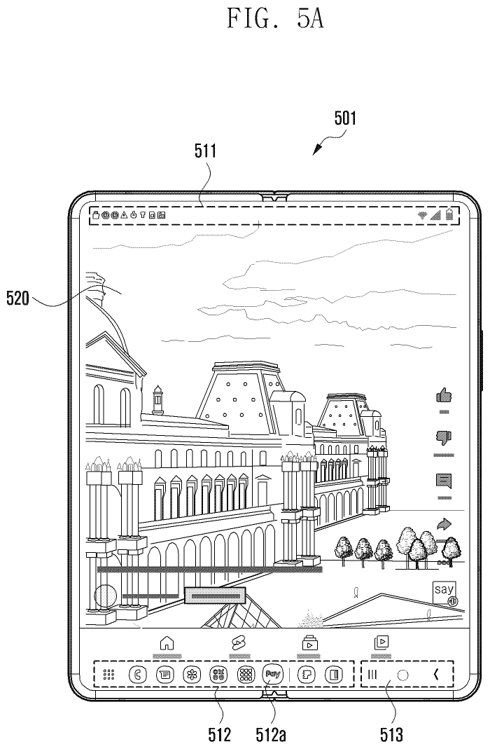

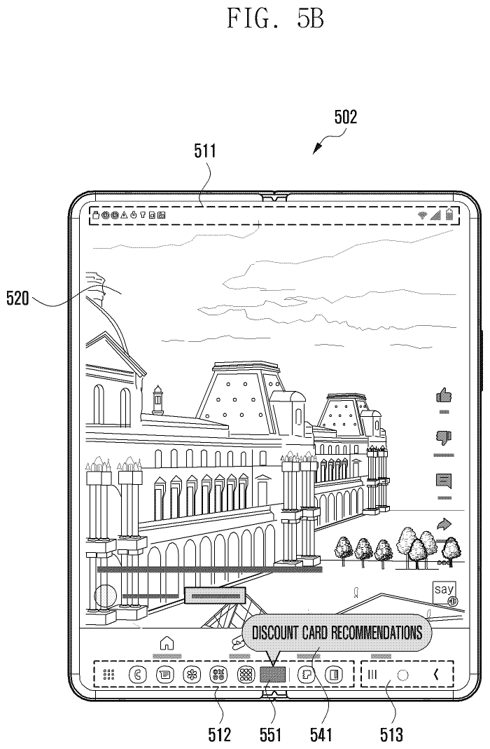

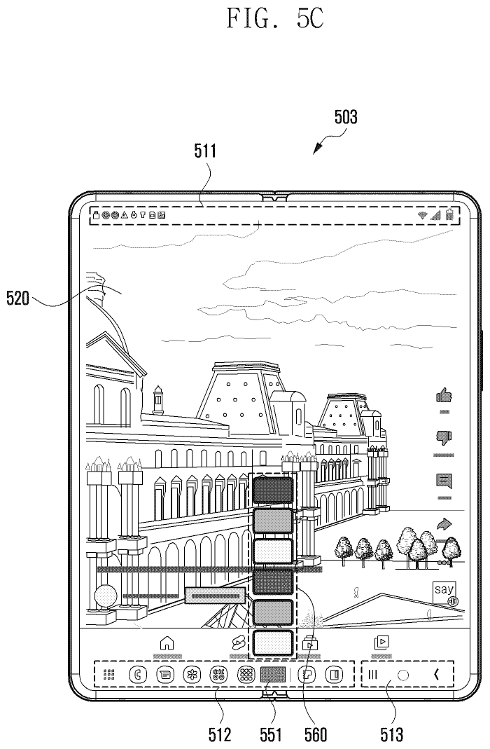

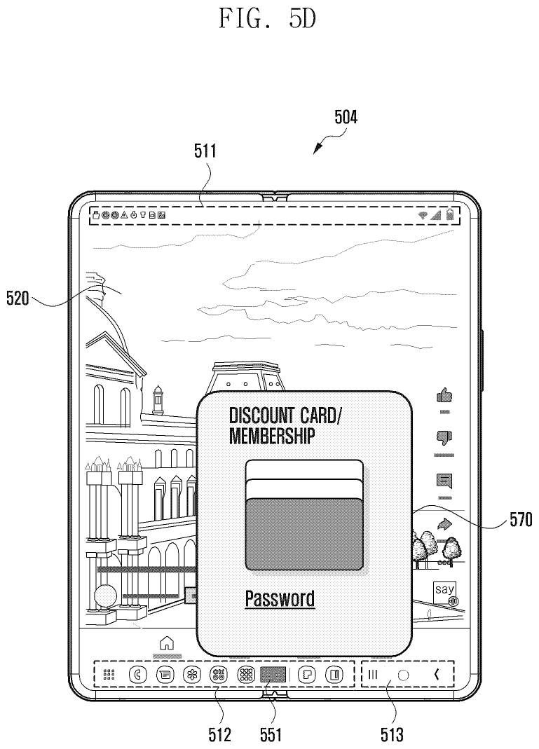

FIGS. 5A, 5B, 5C, and 5D are drawings for describing operations for managing a screen, based on notification information and user inputs, in a portable electronic device 200 according to various embodiments of the disclosure.

Referring to FIG. 5A, the processor 299 may designate the playback screen 520 as a surface to be displayed on the second layer, and may designate the status bar 511, the task bar 512, and the navigation bar 513 as surfaces to be displayed on the first layer. The processor 299 may designate the display position of the playback screen 520 on the second layer to be the screen center. Alternatively, the processor 299 may designate the entire display area of the display 220 as the area in which the playback screen 520 is to be displayed. The processor 299 may designate the display position of the status bar 511 on the first layer to be the screen top which is at a distance from the screen center, and may designate the display position of the task bar 512 and the navigation bar 513 on the first layer to be the screen bottom which is at a distance from the screen center. Based on the designation, the processor 299 may synthesize the first layer surface and the second layer surface into a first frame 501 and may write the same in the frame buffer 221. The display 220 may scan the frame buffer 221 so as to acquire and display the first frame 501. The task bar 512 may include an icon 512a corresponding to the card application 245.

The processor 299 may recognize the user's location by using the wireless communication circuit 210. Based on the recognized location and the time of stay at the location satisfying a designated condition, the processor 299 may determine that a card-related message (e.g., a message for recommending cards that offer the user discounts during shopping at the current store) is notification information to be provided to the user. For example, the processor 299 may receive a card-related message as a push notification from a card company's server that supports an online service through the wireless communication circuit 210, may generate notification information based on the content of the received message, and may store the same in the memory 288. Based on the recognized location and the time of stay at the location satisfying a designated condition, the processor 299 may acquire the card-related message from the memory 288.

Referring to FIG. 5B, the processor 299 may designate the notification information 541 as the first layer surface together with the status bar 511, the task bar 512, and the navigation bar 513 which have previously been classified as belonging to the first layer surface. Based on the designation, the processor 299 may synthesize the first layer surface and the second layer surface (playback screen 520) into a second frame 502 and may write the same in the frame buffer 221. The display 220 may scan the frame buffer 221 so as to acquire and display the second frame 502. Based on a first icon 512a (refer to FIG. 5A) which represents a card application 245 being displayed through the task bar 512, the processor 299 may display a second icon 551 (e.g., an icon having a basic shape of a square card) having a different shape from the first icon 512a (e.g., an icon including the wording “pay”) on the task bar 512, instead of the first icon 512a. The processor 299 may receive the user's touch input regarding the notification information 541 displayed on the first layer from the display 220. The processor 299 may display the second icon 551 while the notification information 541 is displayed. In case that no touch input is received within a specified time, thereby ending the display of the notification information 541, the processor 299 may end the display of the second icon 551 and may display the first icon 512a again in the corresponding position.

Referring to FIG. 5C, based on the user's touch input regarding notification information 441 (FIG. 5B) displayed on the first layer being received, and an icon 512a corresponding to a card application 245 configured to receive messages being configured to be provided through the task bar 512, the processor 299 may acquire card images designated with regard to respective card numbers stored in the memory 288 from the card information 250. In addition, the processor 299 may designate the first card screen 560 as the execution screen of the card application 245, instead of the notification information 541, as the first layer surface together with the status bar 511, the task bar 512, and the navigation bar 513 which have previously been classified as belonging to the first layer surface. The processor 299 may include the card images acquired from the card information 250 on the first card screen 560. Based on the designation, the processor 299 may synthesize the first layer surface and the second layer surface into a third frame 503 and may write the same in the frame buffer 221. The display 220 may scan the frame buffer 221 so as to acquire and display the third frame 503. The processor 299 may receive a touch input regarding a specific card image on the first card screen 560 from the display 220. The processor 299 may display the second icon 551 while the first card screen 560 is displayed. In case that no touch input is received within a specified time, thereby ending the display of the first card screen 560, the processor 299 may end the display of the second icon 551 and may display the first icon 512a again in the corresponding position.

Referring to FIG. 5D, based on a touch input regarding a specific card image being received on the first card screen 560, and an icon 512a (FIG. 5A) corresponding to the card application 245 being configured to be provided through the task bar 512, the processor 299 may maintain the layer of the playback screen 520 intact or may change the same to a lower layer. In addition, the processor 299 may configure the second card screen 570 to be smaller than the size of the playback screen 520, and may designate the second card screen 570 as a layer (e.g., first layer) higher than the layer designated for the playback screen 520. The processor 299 may designate the status bar 511, the task bar 512, and the navigation bar 513 as a layer higher than the layer designated for the playback screen 520. For example, in case that the second card screen 570 is designated as the first layer, and the playback screen 520 is designated as the third layer, the status bar 511, the task bar 512, and the navigation bar 513 may be designated as the second layer. The processor 299 may synthesize the designated layer surfaces into a fourth frame 504 and may write the same in the frame buffer 221. The display 220 may scan the frame buffer 221 so as to acquire and display the fourth frame 504. The processor 299 may display the second icon 551 while the second card screen 570 is displayed. In case that the display of the second card screen 570 is ended, the processor 299 may end the display of the second icon 551 and may display the first icon 512a again at the corresponding position.

The icon 512a (FIG. 5A) corresponding to the card application 245 may not be configured to be provided through the task bar 512, and no icon 512a (FIG. 5A) may accordingly exist on the task bar 512, unlike the above-described embodiment. In such a case, the processor 299 may display the third card screen of the card application 245 in the corresponding position, instead of the playback screen 520. For example, the processor 299 may designate the media player 242 as a background process and may designate the card application 245 as a foreground process. Based on the designation, the processor 299 may designate the third card screen as a surface to be displayed on the second layer, and may designate the status bar 511, the task bar 512, and the navigation bar 513 as surfaces to be displayed on the first layer. The third card screen is larger than the second card screen 570 (e.g., has the same size as the playback screen 520). Based on the designation, the processor 299 may synthesize the first layer surface and the second layer surface into a fifth frame and may write the same in the frame buffer 221. The display 220 may scan the frame buffer 221 so as to acquire and display the fifth frame.

According to an embodiment, the processor 299 may determine the display position of the first card screen 560, based on the position in which the corresponding notification information 541 is displayed. For example, the processor 299 may display the first card screen 560 at or near the location at which the notification information 541 is displayed. According to an embodiment, the processor 299 may determine the display position of the first card screen 560, based on a user input. For example, the processor 299 may receive a touch input from the display 220 as the user's response to the display of the notification information 541. The processor 299 may display the first card screen 560 at the location at which the touch input has occurred on the display 220.

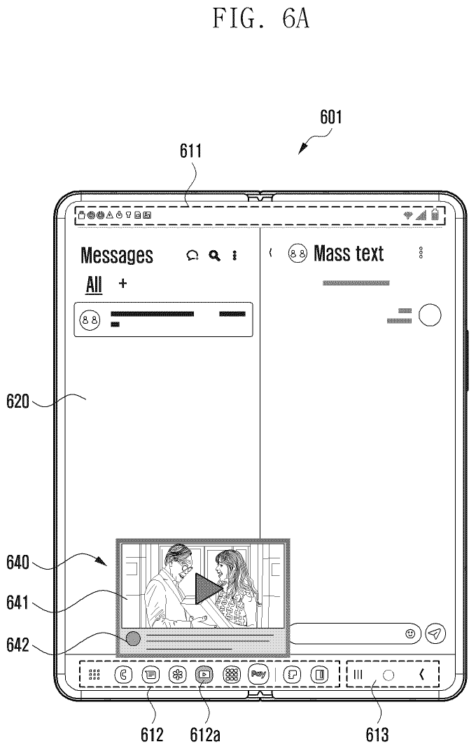

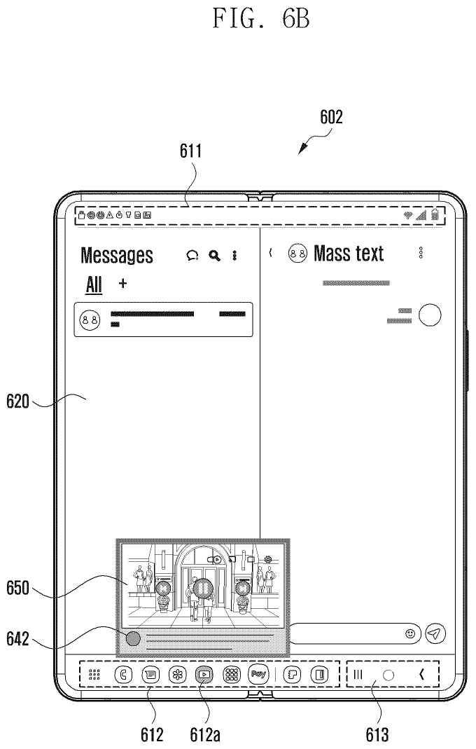

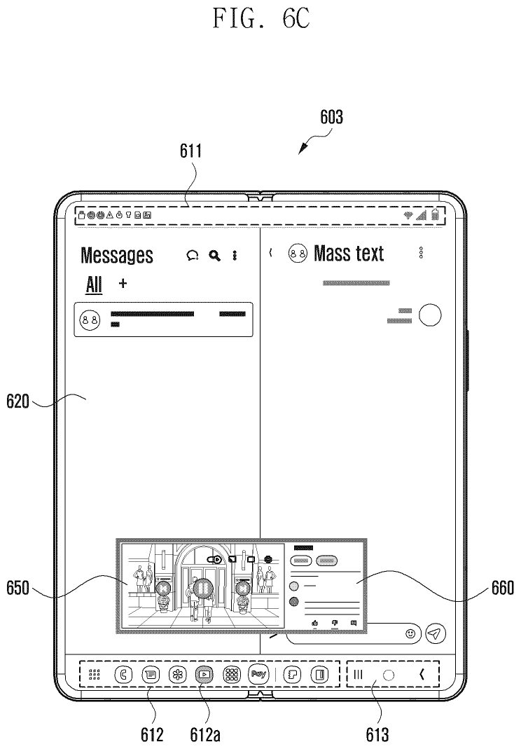

FIGS. 6A, 6B, and 6C are drawings for describing operations for managing a screen, based on notification information and user inputs, in a portable electronic device according to various embodiments of the disclosure.

Referring to FIG. 6A, the processor 299 may receive a streaming-related message (e.g., a thumbnail image 641 and a summary 642 related to a video newly uploaded by a subscribed video channel) from an external device (e.g., a streaming support server) through the wireless communication circuit 210. The processor 299 may recognize the received message as notification information to be visually provided to the user, and may generate notification information 640, based on the content of the message. The processor 299 may designate the notification information 640 as a first layer surface together with the status bar 611, the task bar 612, and the navigation bar 613. Based on the designation, the processor 299 may synthesize the first layer surface and the second layer surface (message screen 620) into a first frame 601 and may write the same in the frame buffer 221. The display 220 may scan the frame buffer 221 so as to acquire and display the first frame 601. The processor 299 may receive the user's touch input regarding the thumbnail image 641 or the summary 642 in the notification information 640 from the display 220.

Referring to FIG. 6B, based on the user's touch input regarding the thumbnail image 641 (FIG. 6A) in the notification information 640 being received from the display 220, and an icon 612a corresponding to the media player 242 being configured to be provided through the task bar 612, the processor 299 may receive video streaming data corresponding to the notification information 640 from an external device through the wireless communication circuit 210 by using the media player 242, and may decompress the video streaming data by using a video codec, thereby generating a streaming image 650 to be displayed at a corresponding location instead of the thumbnail image 641. In addition, the processor 299 may designate the streaming image 650 as a first layer surface together with the summary 642, the status bar 611, the task bar 612, and the navigation bar 613 which have previously been classified as belonging to the first layer. Based on the designation, the processor 299 may synthesize the first layer surface and the second layer surface (message screen 620) into a second frame 602 and may write the same in the frame buffer 221. The display 220 may scan the frame buffer 221 so as to acquire and display the second frame 602.

Referring to FIG. 6C, the processor 299 may receive video streaming data and a detailed description 660 which correspond to the notification information 640 from an external device through the wireless communication circuit 210, based on the user's touch input regarding the summary 642 (FIG. 6A) in the notification information 640 displayed on the first layer, by using the media player 242, and may decompress the video streaming data using a video codec, thereby generating a streaming image 650. The processor 299 may designate the streaming image 650 and the detailed description 660 as a first layer surface together with the status bar 611, the task bar 612, and the navigation bar 613 which have previously been classified as belonging to the first layer. Based on the designation, the processor 299 may synthesize the first layer surface and the second layer surface (message screen 620) into a third frame 603 and may write the same in the frame buffer 221. The display 220 may scan the frame buffer (221) so as to acquire and display the third frame 603.

According to an embodiment, the processor 299 may determine the display location of the streaming image 650, based on the location at which the corresponding notification information 640 is displayed. For example, the processor 299 may display the streaming image 650 at or near the location at which the notification information 640 is displayed. According to an embodiment, the processor 299 may determine the display location of the streaming image 650, based on a user input. For example, the processor 299 may receive a touch input from the display 220 as the user's response to the display of the notification information 640. The processor 299 may display the streaming image 650 at the location at which the touch input has occurred on the display 220.

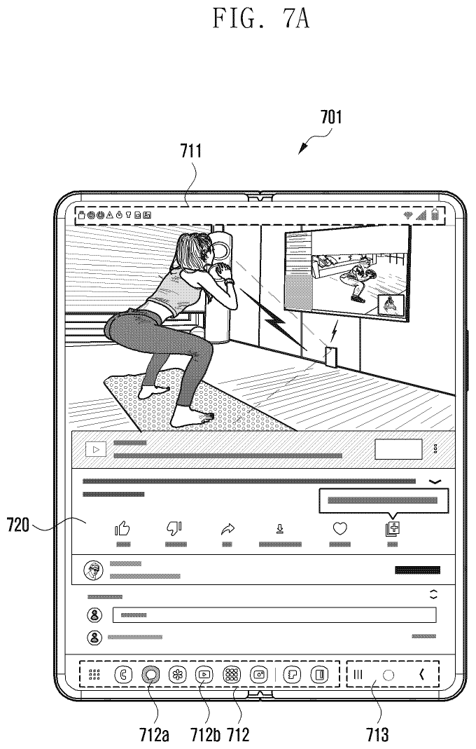

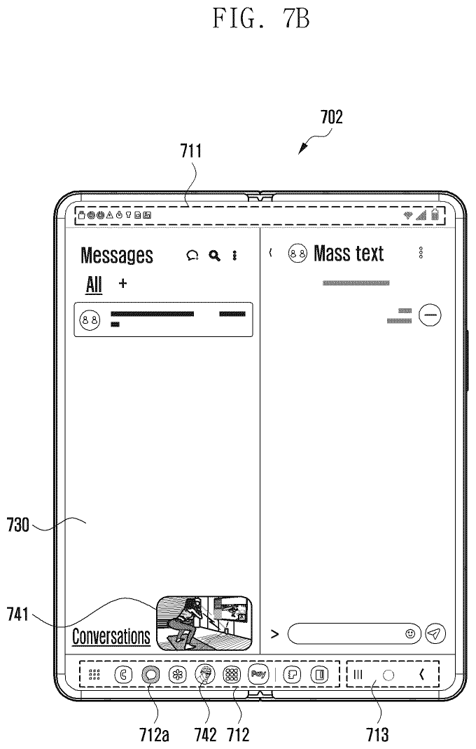

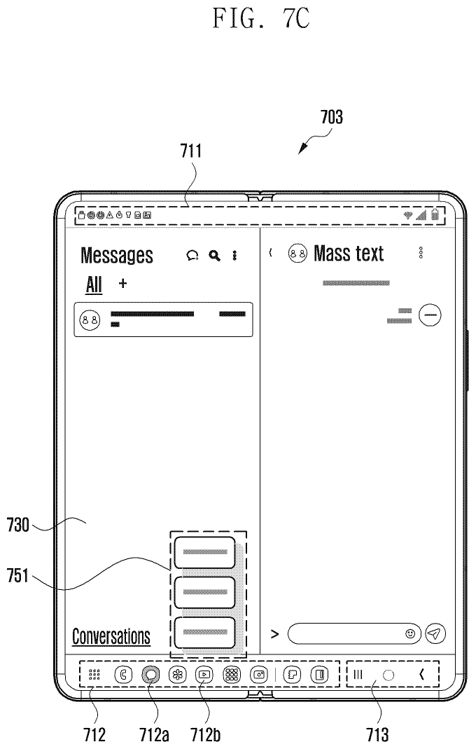

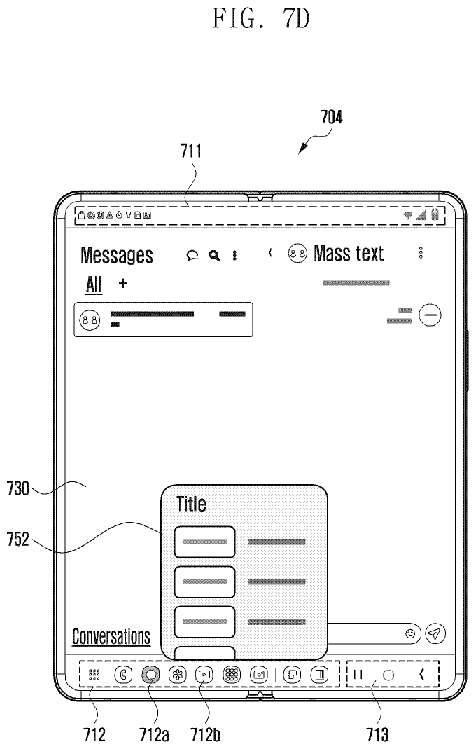

FIGS. 7A, 7B, 7C, and 7D are drawings for describing operations for managing a screen, based on user inputs, in a portable electronic device according to various embodiments of the disclosure.

Referring to FIG. 7A, the processor 299 may designate the first playback screen 720 of the media player 242 for playing (e.g., streaming) a video received from an external device (e.g., a video providing server) through the wireless communication circuit 210 as a surface to be displayed on the second layer, and may designate the status bar 711, the task bar 712, and the navigation bar 713 as surfaces to be displayed on the first layer. The processor 299 may designate the display position of the first playback screen 720 on the second layer to be the screen center. Alternatively, the processor 299 may designate the entire display area of the display 220 as the area in which the first playback screen 720 is to be displayed. The processor 299 may designate the display position of the status bar 711 on the first layer to be to the screen top which is at a distance from the screen center, and may designate the display positions of the task bar 712 and the navigation bar 713 on the first layer to be the screen bottom which is at a distance from the screen center. Based on the designation, the processor 299 may synthesize the first layer surface and the second layer surface into a first frame 701 and may write the same in the frame buffer 221. The display 220 may scan the frame buffer 221 so as to acquire and display the first frame 701. The task bar 712 may include a first icon 712a corresponding to the message application 243 and a second icon 712b corresponding to the media player 242. The processor 299 may receive the user's touch input regarding the first icon 712a on the task bar 712 from the display 220.

Referring to FIG. 7B, the processor 299 may designate the message screen 730 of the message application 243 as a surface to be displayed on the second layer instead of the first playback screen 720, based on the user's touch input regarding the first icon 712a on the task bar 712. The processor 299 may configure the second playback screen 741 of the media player 242 to be smaller than the size of the message screen 730 and may designate the same as a first layer surface. The processor 299 may synthesize the first layer surfaces (the status bar 711, the task bar 712, the navigation bar 713, and the second playback screen 741) and the second layer surface (the message screen 730) into a second frame 702 and may write the same in the frame buffer 221. The display 220 may scan the frame buffer 221 so as to acquire and display the second frame 702. Additionally, the processor 299 may display an image 742 related to the content (e.g., an image showing the profile of a subscribed video channel) on the task bar 712 instead of the second icon 712b (FIG. 7A).

Referring to FIG. 7C, based on completion of playback of the corresponding video through the second playback screen 741 (FIG. 7B), the processor 299 may acquire first content 751 (e.g., the summary of recommended videos) related to the media player 242 to be displayed on the first layer instead of the second playback screen 741 from an external device through the wireless communication circuit 210. The processor 299 may synthesize the first layer surfaces (the status bar 711, the task bar 712, the navigation bar 713, and the first content 751) and the second layer surface (the message screen 730) into a third frame 703 and may write the same in the frame buffer 221. The display 220 may scan the frame buffer 221 so as to acquire and display the third frame 703. Additionally, the processor 299 may display a second icon 712b on the task bar 712 instead of the image 742 (FIG. 7B). The processor 299 may receive the user's touch input regarding the first content 751 from the display 220.

Referring to FIG. 7D, based on the user's touch input regarding the first content 751 (FIG. 7C), the processor 299 may acquire second content 752 (e.g., details of recommended videos) related to the media player 242 to be displayed on the first layer, instead of the first content 751, from an external device through the wireless communication circuit 210. The processor 299 may synthesize the first layer surfaces (the status bar 711, the task bar 712, the navigation bar 713, and the second content 752) and the second layer surface (the message screen 730) into a fourth frame 704 and may write the same in the frame buffer 221. The display 220 may scan the frame buffer 221 so as to acquire and display the fourth frame 704.

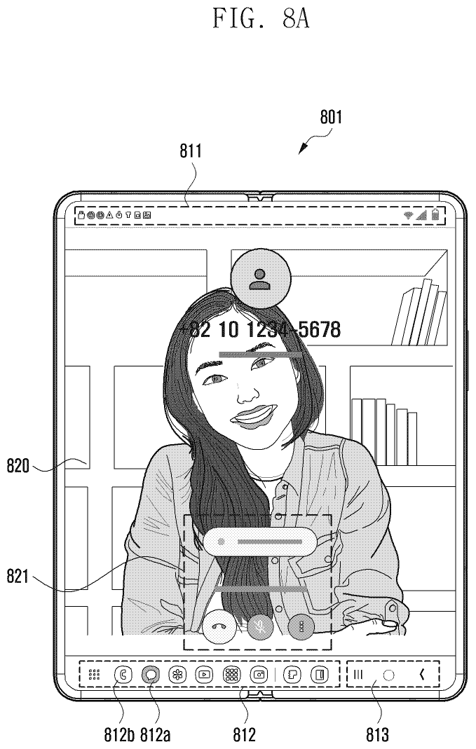

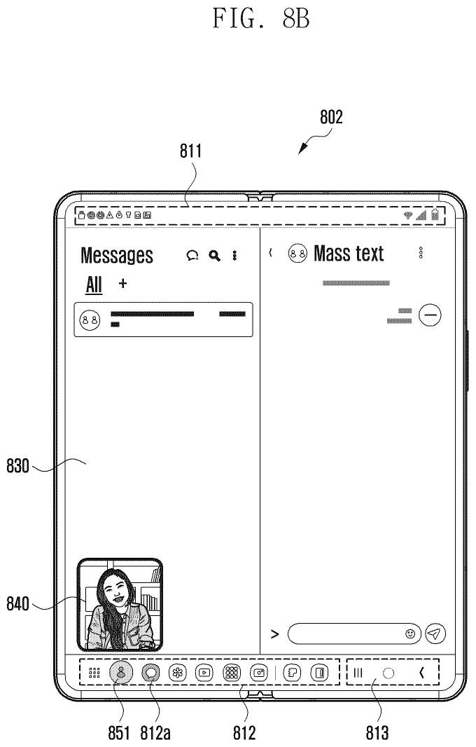

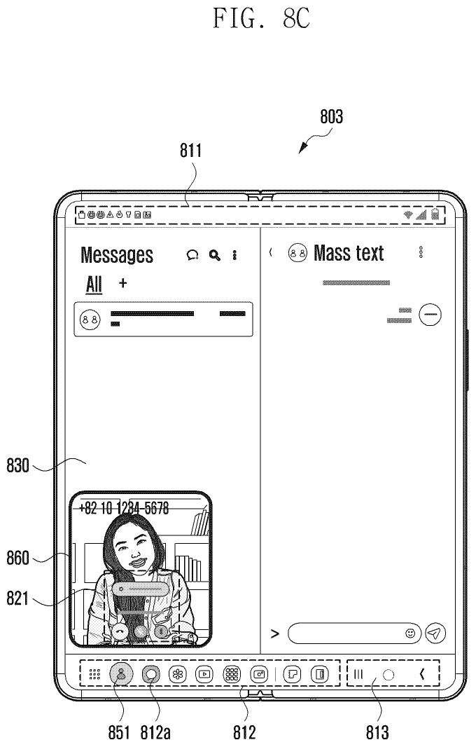

FIGS. 8A, 8B, and 8C are drawings for describing operations for managing a screen, based on user inputs, in a portable electronic device according to various embodiments of the disclosure.

Referring to FIG. 8A, the processor 299 may designate a first call screen 820 (e.g., a video call screen) as an execution screen of a call application 244 for supporting calls between an external device and users through the wireless communication circuit 210 as a surface to be displayed on the second layer. The processor 299 may designate the status bar 811, the task bar 812, and the navigation bar 813 as surfaces to be displayed on the first layer. In addition, the processor 299 may designate a UI element 821 configured to support interactions with the user in relation to calls as a first layer surface. The processor 299 may designate the display position of the first call screen 820 on the second layer to be the screen center. Alternatively, the processor 299 may designate the entire display area of the display 220 as the area in which the first call screen 820 is to be displayed. The processor 299 may designate the display position of the status bar 811 on the first layer to be the screen top which is at a distance from the screen center, and may designate the display position of the task bar 812 and the navigation bar 813 on the first layer to be the screen bottom which is at a distance from the screen center. The processor 299 may designate the display position of the UI element 821 so as not to overlap other first layer surfaces (the status bar 811, the task bar 812, and the navigation bar 813). Based on the designation, the processor 299 may synthesize the first layer surfaces and the second layer surface into a first frame 801 and may write the same in the frame buffer 221. The display 220 may scan the frame buffer 221 so as to acquire and display the first frame 801. The task bar 812 may include a first icon 812a corresponding to the message application 243 and a second icon 812b corresponding to the call application 244. The processor 299 may receive the user's touch input regarding the first icon 812a on the task bar 812 from the display 220.

Referring to FIG. 8B, the processor 299 may designate the message screen 830 of the message application 243 as a second layer surface, instead of the first call screen 820, based on the user's touch input regarding the first icon 812a on the task bar 812. The processor 299 may designate the second call screen 840, from which the UI element 821 (FIG. 8A) configured to support interactions with the user in relation to calls is omitted, to be smaller than the size of the message screen 830, and may designate the second call screen 840 as a first layer surface. The processor 299 may synthesize the first layer surfaces (the status bar 811, the task bar 812, the navigation bar 813, and the second call screen 840) and the second layer surface (the message screen 830) into a second frame 802 and may write the same in the frame buffer 221. The display 220 may scan the frame buffer 221 so as to acquire and display the second frame 802. Additionally, the processor 299 may display an image 851 related to calls (e.g., an image showing the calling counterpart's profile) on the task bar 812 instead of the second icon 812b (FIG. 8A). The processor 299 may receive the user's touch input regarding the second call screen 840 from the display 220. If the call is ended, the processor 299 may end the display of the second call screen 840 and the image 851 and may display the second icon 812b at the location at which the image 851 is displayed.

Referring to FIG. 8C, the processor 299 may generate a third call screen 860 which again includes a UI element 821 configured to be displayed on the first layer instead of the second call screen 840, based on the user's touch input regarding the second call screen 840, the third call screen 860 having a smaller size than the first call screen 820. The processor 299 may synthesize the first layer surfaces (the status bar 811, the task bar 812, the navigation bar 813, and the third call screen 860) and the second layer surface (the message screen 830) into a third frame 803 and may write the same in the frame buffer 221. The display 220 may scan the frame buffer 221 so as to acquire and display the third frame 803. If the call is ended, the processor 299 may end the display of the third call screen 860 and the image 851 and may display the second icon 812b at the location at which the image 851 is displayed.

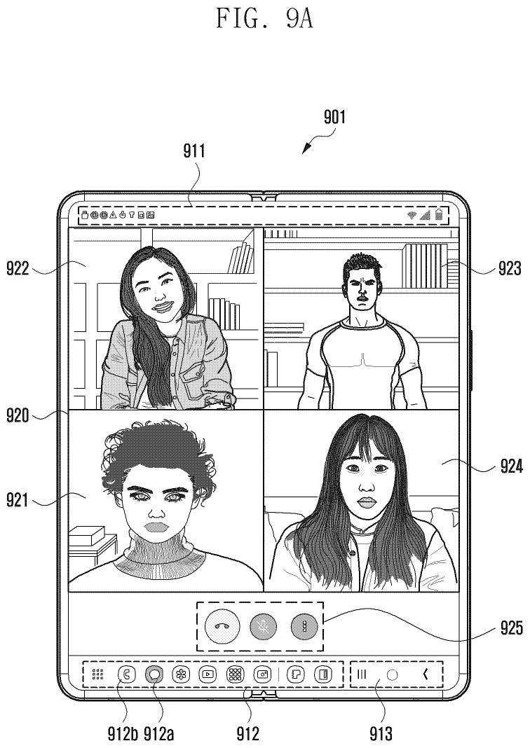

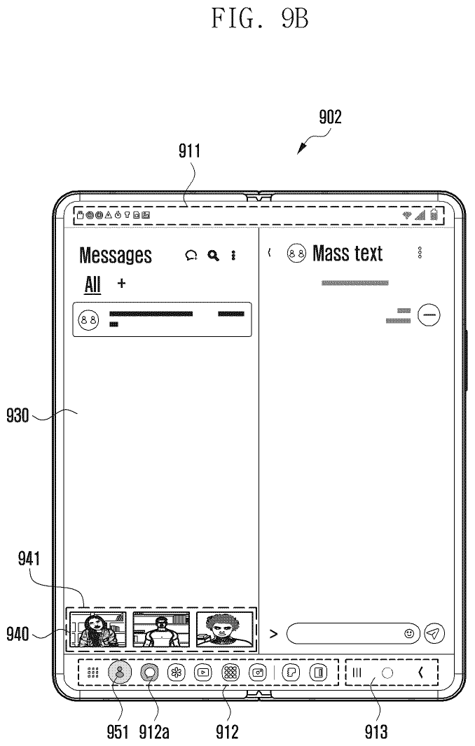

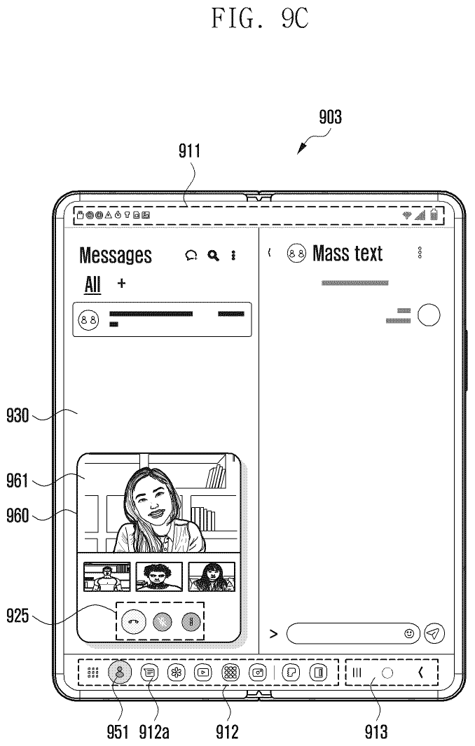

FIGS. 9A, 9B, and 9C are drawings for describing operations for managing a screen, based on user inputs, in a portable electronic device according to various embodiments of the disclosure.

Referring to FIG. 9A, the processor 299 may designate a first call screen 920 (e.g., a group video call screen), which is an execution screen of a call application 244 for supporting calls between an external device and users through the wireless communication circuit 210, as a surface to be displayed on the second layer. The processor 299 may configure the first call screen 920 so as to include a user window 921 for displaying video call images transmitted from the portable electronic device 200 to the external device through the wireless communication circuit 210, call counterpart windows 922, 923, and 924 for displaying video call images received from the external device to the portable electronic device 200 through the wireless communication circuit 210, and a UI element 925 configured to support interactions with the user in relation to calls. The processor 299 may designate the status bar 911, the task bar 912, and the navigation bar 913 as surfaces to be displayed on the first layer. The processor 299 may designate the display position of the first call screen 920 on the second layer to be the screen center. Alternatively, the processor 299 may designate the entire display area of the display 220 as the area in which the first call screen 920 is to be displayed. The processor 299 may designate the display position of the status bar 911 on the first layer to be the screen top which is at a distance from the screen center, and may designate the display position of the task bar 912 and the navigation bar 913 on the first layer to the screen bottom which is at a distance from the screen center. Based on the designation, the processor 299 may synthesize the first layer surfaces and the second layer surface into a first frame 901 and may write the same in the frame buffer 221. The display 220 may scan the frame buffer 221 so as to acquire and display the first frame 901. The task bar 912 may include a first icon 912a corresponding to the message application 243 and a second icon 912b corresponding to the call application 244. The processor 299 may receive the user's touch input regarding the first icon 912a on the task bar 912 from the display 220.

Referring to FIG. 9B, the processor 299 may designate the message screen 930 of the message application 243 as the second layer surface instead of the first call screen 920, based on the user's touch input regarding the first icon 912a on the task bar 912. The processor 299 may configure the second call screen 940, from which the UI element 925 (FIG. 9A) and the user window 921 (FIG. 9A) are omitted, to be smaller than the size of the message screen 930, and may designate the second call screen 940 as a first layer surface to be displayed on the first layer. The processor 299 may synthesize the first layer surfaces (the status bar 911, the task bar 912, the navigation bar 913, and the second call screen 940) and the second layer surface (the message screen 930) into a second frame 902 and may write the same in the frame buffer 221. The display 220 may scan the frame buffer 221 so as to acquire and display the second frame 902. Additionally, the processor 299 may display an image 951 related to calls (e.g., an image showing contact information) on the task bar 912 instead of the second icon 912b (FIG. 9A). The processor 299 may receive the user's touch input regarding a specific counterpart window 941 on the second call screen 940 from the display 220. If the call is ended, the processor 299 may end the display of the second call screen 940 and the image 951 and may display the second icon 912b at the location at which the image 951 is displayed.

Referring to FIG. 9C, based on the user's touch input selection of the window 941 (FIG. 9B) of a specific counterpart among counterparts who joint the call on the second call screen 940 (FIG. 9B), the processor 299 may generate a third call screen 960 which again includes the UI element 925 configured to be displayed on the first layer instead of the second call screen 940, the third call screen 960 being configured such that the selected counterpart's window 961 is larger than other windows and is smaller than the first call screen 920. The processor 299 may synthesize the first layer surfaces (the status bar 911, the task bar 912, the navigation bar 913, and the third call screen 960) and the second layer surface (the message screen 930) into a third frame 903 and may write the same in the frame buffer 221. The display 220 may scan the frame buffer 221 so as to acquire and display the third frame 903. If the call is ended, the processor 299 may end the display of the third call screen 960 and the image 951 and may display the second icon 912b at the location at which the image 951 is displayed.

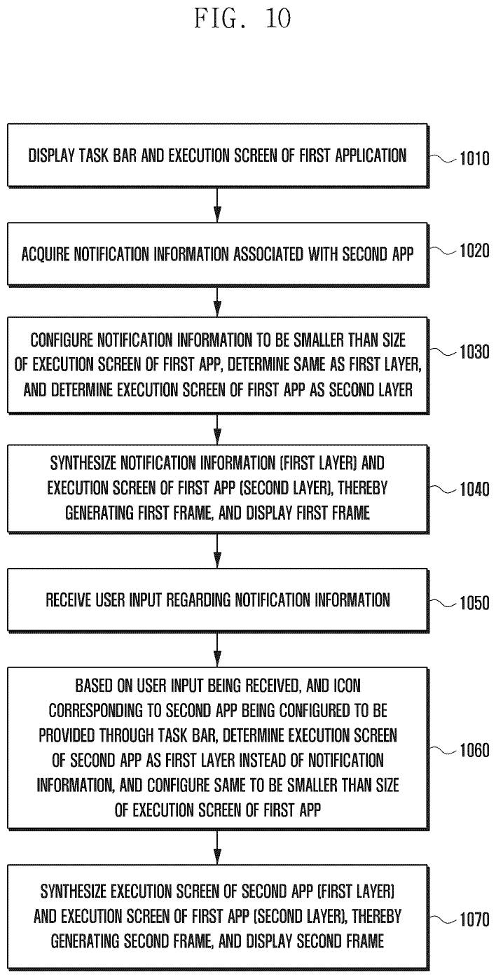

FIG. 10 is a flowchart for describing operations for managing a screen in a portable electronic device according to an embodiment of the disclosure.

In operation 1010, the processor 299 may display a task bar and an execution screen (e.g., the playback screen 320 or 520 or the message screen 620) of a first application (hereinafter, simply referred to as an “app”).

In operation 1020, the processor 299 may acquire notification information associated with a second application (e.g., the notification information 341, 541 or 640).

In operation 1030, the processor 299 may configure the notification information to be smaller than the size of the execution screen of the first app, may determine the same as a first layer, and may determine the execution screen of the first app as a second layer, which has a lower priority of display than the first layer.

In operation 1040, the processor 299 may synthesize the notification information determined as the first layer and the execution screen of the first app determined as the second layer, thereby generating a first frame (e.g., the first frame 601 or the second frame 302 or 502), and may display the first frame on the display 220.

In operation 1050, the processor 299 may receive a user input regarding the notification information from the display 220.

In operation 1060, based on a user input regarding the notification information being received, and an icon corresponding to the second app being configured to be provided through the task bar, the processor 299 may determine the execution screen of the second app (e.g., the first message screen 360, the card screen 560 or 570, or the streaming image 650) as the first layer instead of the notification information, and may configure the same to be smaller than the size of the execution screen of the first app.

In operation 1070, the processor 299 may synthesize the execution screen of the second app determined as the first layer and the execution screen of the first app determined as the second layer, thereby generating a second frame (e.g., the second frame 602, the third frame 303, 503 or 603, or the fourth frame 504), and may display the second frame on the display 220.

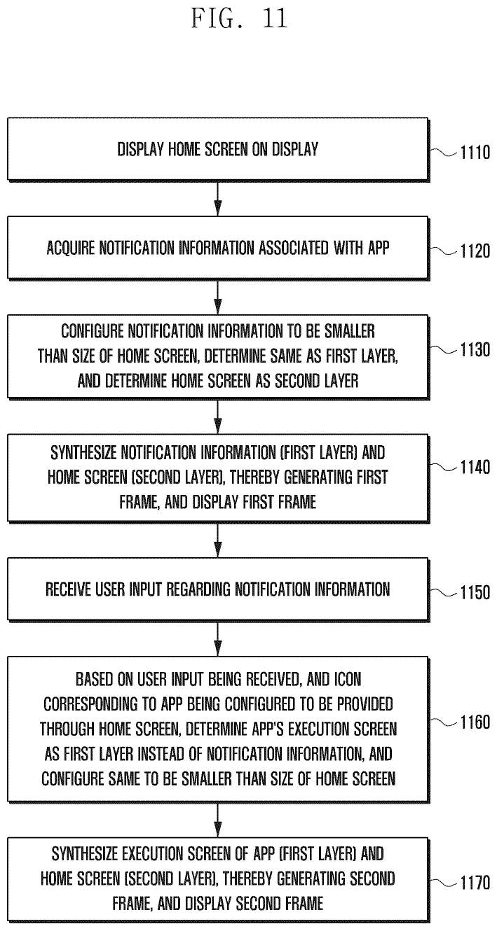

FIG. 11 is a flowchart for describing operations for managing a screen in a portable electronic device according to an embodiment of the disclosure.

In operation 1110, the processor 299 may display a home screen (e.g., the home screen 420) on the display 220.

In operation 1120, the processor 299 may acquire notification information (e.g., the message 441) associated with an app.

In operation 1130, the processor 299 may configure the notification information to be smaller than the size of the home screen, may determine the same as a first layer, and may determine the home screen as a second layer which has a lower priority of display than the first layer.

In operation 1140, the processor 299 may synthesize the notification information determined as the first layer and the home screen determined as the second layer, thereby generating a first frame (e.g., the second frame 402), and may display the first frame on the display 220.

At operation 1150, the processor 299 may receive a user input regarding the notification information from the display 220.

In operation 1160, based on a user input being received, and an icon corresponding to the application being configured to be provided through the home screen, the processor 299 may determine the app's execution screen (e.g., the message screen 460) as the first layer instead of notification information, and may configure the same to be smaller than the size of the home screen.

In operation 1170, the processor 299 may synthesize the execution screen of the app determined as the first layer and the home screen determined as the second layer, thereby generating a second frame (e.g., the third frame 403), and may display the second frame on the display 220.

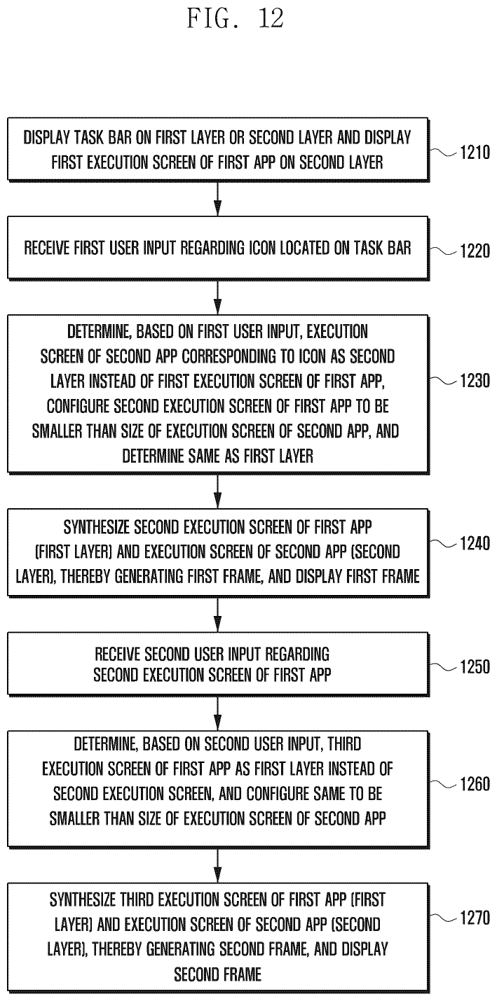

FIG. 12 is a flowchart for describing operations for managing a screen in a portable electronic device according to an embodiment of the disclosure.

In operation 1210, the processor 299 may display a task bar on the first layer or the second layer which has a lower priority of display than the first layer, and may display a first execution screen (e.g., the first playback screen 720 or the first call screen 820 or 920) of a first app on the second layer.

At operation 1220, the processor 299 may receive a first user input regarding an icon located on the task bar from the display 220.

In operation 1230, the processor 299 determines, based on the first user input, an execution screen (e.g., the message screen 730, 830 or 930) of a second app corresponding to an icon as the second layer instead of the first execution screen of the first app, may configure the second execution screen (e.g., the second playback screen 741 or the second call screen 840 or 940) of the first app to be smaller than the size of the execution screen of the second app, and may determine the same as the first layer.

In operation 1240, the processor 299 may synthesize the second execution screen of the first app determined as the first layer and the execution screen of the second app determined as the second layer, thereby generating a first frame (e.g., the second frame 702, 802 or 902), and may display the first frame on the display 220.

In operation 1250, the processor 299 may receive a second user input regarding the second execution screen of the first app from the display 220.

In operation 1260, the processor 299 may determine, based on the second user input, the third execution screen (e.g., the first content 751, the second content 752, or the third call screen 860 or 960) of the first app as the first layer instead of the second execution screen of the first app, and may configure the same to be smaller than the size of the execution screen of the second app.

In operation 1270, the processor 299 may synthesize the third execution screen of the first app determined as the first layer and the execution screen of the second app determined as the second layer, thereby generating a second frame (e.g., the third frame 703, 803 or 903 or the fourth frame 704), and may display the second frame on the display 220.

According to an embodiment, a portable electronic device includes a touch-sensitive display, a wireless communication circuit, a processor operatively connected to the display and the wireless communication circuit, and memory operatively connected to the processor. The memory may store instructions which, when executed by the processor, cause the portable electronic device to display a task bar and an execution screen (e.g., the playback screen 320 or 520 or the message screen 620) of a first application on the display. The instructions may cause the portable electronic device to acquire notification information (e.g., 3341, 541, or 640) associated with a second application through the wireless communication circuit. The instructions may cause the portable electronic device to configure the notification information to be smaller than the size of the execution screen of the first application and determine the notification information as a first layer. The instructions may cause the portable electronic device to determine the execution screen of the first application as a second layer having a lower priority of display than the first layer. The instructions may cause the portable electronic device to generate a first frame by synthesizing the notification information determined as the first layer and the execution screen of the first application determined as the second layer together, and display the first frame on the display. The instructions may cause the portable electronic device to, based on a user input regarding the notification information being received through the display, and an icon corresponding to the second application being configured to be provided through the task bar, determine the execution screen (e.g., the first message screen 360, the card screen 560 or 570, or the streaming image 650) of the second application as the first layer, instead of the notification information, configure the execution screen of the second application to be smaller than the size of the execution screen of the first application, generate a second frame by synthesizing the execution screen of the second application determined as the first layer and the execution screen of the first application determined as the second layer, and display the second frame on the display.

The instructions may cause the portable electronic device to receive a conversation-related message from an external device through the wireless communication circuit, and recognize the received message as the notification information to be provided to a user.

The instructions may cause the portable electronic device to recognize the location of the portable electronic device by using the wireless communication circuit, and determine a card-related message as the notification information, based on the recognized location and the time of stay at the location satisfying a designated condition.

The instructions may cause the portable electronic device to receive a streaming-related message from an external device through the wireless communication circuit, and recognize the received message as the notification information to be provided to a user.

The instructions may cause the portable electronic device to display an image related to the received message on the task bar instead of the icon while the notification information is displayed.

The instructions may cause the portable electronic device to end display of the image concurrently with ending of display of the notification information, and resume display of the icon.

According to an embodiment, a portable electronic device includes a touch-sensitive display, a wireless communication circuit, a processor operatively connected to the display and the wireless communication circuit, and memory operatively connected to the processor. The memory may store instructions which, when executed by the processor, cause the portable electronic device to display a home screen on the display. The instructions may cause the portable electronic device to acquire notification information (e.g., the message 441) associated with an application through the wireless communication circuit. The instructions may cause the portable electronic device to configure the notification information to be smaller than the size of the home screen and determine the notification information as a first layer. The instructions may cause the portable electronic device to determine the home screen as a second layer having a lower priority of display than the first layer. The instructions may cause the portable electronic device to generate a first frame by synthesizing the notification information determined as the first layer and the home screen determined as the second layer, and display the first frame on the display. The instructions may cause the portable electronic device to, based on a user input regarding the notification information being received through the display, and an icon corresponding to the application being configured to be provided through the home screen, determine the execution screen (e.g., the message screen 460) of the application as the first layer instead of the notification information, configure the execution screen of the application to be smaller than the size of the home screen, generate a second frame by synthesizing the execution screen of the application determined as the first layer and the home screen determined as the second layer, and display the second frame on the display.

The instructions may cause the portable electronic device to receive a conversation-related message from an external device through the wireless communication circuit, and recognize the received message as the notification information to be provided to a user.

The instructions may cause the portable electronic device to recognize the location of the portable electronic device by using the wireless communication circuit, and determine a card-related message as the notification information, based on the recognized location and the time of stay at the location satisfying a designated condition.

The instructions may cause the portable electronic device to receive a streaming-related message from an external device through the wireless communication circuit, and recognize the received message as the notification information to be provided to a user.

The instructions may cause the portable electronic device to display an image related to the received message on the task bar instead of the icon while the notification information is displayed.

The instructions may cause the portable electronic device to end display of the image concurrently with ending of display of the notification information, and resume display of the icon.

According to an embodiment, a portable electronic device includes a touch-sensitive display, a wireless communication circuit, a processor operatively connected to the display and the wireless communication circuit, and memory operatively connected to the processor. The memory may store instructions which, when executed by the processor, cause the portable electronic device to display a task bar on a first layer or on a second layer having a lower priority of display than the first layer, and display a first execution screen (e.g., 720, 820, or 920) of a first application on the second layer. The instructions may cause the portable electronic device to receive a first user input regarding an icon located on the task bar from the display. The instructions may cause the portable electronic device to determine an execution screen (e.g., the message screen 730, 830, or 930) of a second application corresponding to the icon as the second layer instead of the first execution screen, based on the first user input, configure a second execution screen (e.g., the second playback screen 741 or the second call screen 840 or 940) of the first application to be smaller than the size of the execution screen of the second application, and determine the second execution screen of the first application as the first layer. The instructions may cause the portable electronic device to generate a first frame by synthesizing the second execution screen determined as the first layer and the execution screen of the second application determined as the second layer, and display the first frame on the display. The instructions may cause the portable electronic device to receive a second user input regarding the second execution screen from the display. The instructions may cause the portable electronic device to determine a third execution screen (e.g., the first content 751, the second content 752, or the third call screen 860 or 960) of the first application as the first layer instead of the second execution screen, based on the first user input, and configure the third execution screen of the first application to be smaller than the size of the execution screen of the second application. The instructions may cause the portable electronic device to generate a second frame by synthesizing the third execution screen determined as the first layer and the execution screen of the second application determined as the second layer, and display the second frame on the display.

The instructions may cause the portable electronic device to display a first playback screen of a media player for playing videos received from an external device through the wireless communication circuit, as the first execution screen. The instructions may cause the portable electronic device to display a message screen of a message application as the execution screen of the second application. The instructions may cause the portable electronic device to display a second playback screen having a smaller size than the message screen as the second execution screen. The instructions may cause the portable electronic device to display video-related content as the third execution screen.

The instructions may cause the portable electronic device to display a first call screen of a call application for supporting calls with an external device through the wireless communication circuit, as the first execution screen. The instructions may cause the portable electronic device to display a message screen of a message application as the execution screen of the second application. The instructions may cause the portable electronic device to display a second call screen having a smaller size than the message screen as the second execution screen. The instructions may cause the portable electronic device to display a third call screen including a UI element configured to support interactions with users in connection with calls, and having a smaller size than the message screen, and the third execution screen.

According to an embodiment, a portable electronic device may include a touch-sensitive display, a wireless communication circuit, a processor operatively connected to the display and the wireless communication circuit, and memory operatively connected to the processor. The memory may store instructions which, when executed by the processor, cause the portable electronic device to generate a first frame by synthesizing a task bar and an execution screen of a first application, and display the first frame on the display. The instructions may cause the portable electronic device to acquire notification information associated with a second application through the wireless communication circuit. The instructions may cause the portable electronic device to configure the notification information to be smaller than the size of the execution screen of the first application and determine the notification information as a first layer. The instructions may cause the portable electronic device to determine the execution screen of the first application as a second layer having a lower priority of display than the first layer. The instructions may cause the portable electronic device to generate a second frame by synthesizing the notification information determined as the first layer and the execution screen of the first application determined as the second layer together with the task bar, and display the second frame on the display. The instructions may cause the portable electronic device to, based on a user input regarding the notification information being received through the display, and an icon corresponding to the second application being configured to be provided through the task bar, determine the execution screen of the second application as the first layer, configure the execution screen of the second application to be smaller than the size of the execution screen of the first application, and generate a third frame by synthesizing the execution screen of the second application determined as the first layer and the execution screen of the first application determined as the second layer together with the task bar, and display the third frame on the display.

The instructions may cause the portable electronic device to configure the notification information (e.g., 341, 441, 541, or 640), based on the icon being configured to be provided through the task bar, display an image related to the received message on the task bar instead of the icon, and display the notification information at a location adjacent to the task bar.

According to an embodiment, a non-transitory recording medium configured to store instructions readable by a process of a portable electronic device is provided. The instructions, when executed by the processor, may cause the portable electronic device to generate a first frame by synthesizing a task bar and an execution screen of a first application, and display the first frame on the display. The instructions may cause the portable electronic device to acquire notification information associated with a second application through the wireless communication circuit. The instructions may cause the portable electronic device to configure the notification information to be smaller than the size of the execution screen of the first application and determine the notification information as a first layer. The instructions may cause the portable electronic device to determine the execution screen of the first application as a second layer having a lower priority of display than the first layer. The instructions may cause the portable electronic device to generate a second frame by synthesizing the notification information determined as the first layer and the execution screen of the first application determined as the second layer together with the task bar, and display the second frame on the display. The instructions may cause the portable electronic device to, based on a user input regarding the notification information being received through the display, and an icon corresponding to the second application being configured to be provided through the task bar, determine the execution screen of the second application as the first layer, configure the execution screen of the second application to be smaller than the size of the execution screen of the first application, generate a third frame by synthesizing the execution screen of the second application determined as the first layer and the execution screen of the first application determined as the second layer together with the task bar, and display the third frame on the display.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A portable electronic device comprising:
a touch-sensitive display;
a wireless communication circuit;
memory, comprising one or more storage media, storing instructions; and
at least one processor operatively connected to the touch-sensitive display, the wireless communication circuit, and the memory,
wherein the instructions, when executed by the at least one processor individually or collectively, cause the portable electronic device to:
generate a first frame by synthesizing a task bar and an execution screen of a first application, and display the first frame on the touch-sensitive display,
acquire a message associated with a second application through the wireless communication circuit,
configure notification information associated with the acquired message to be smaller than a size of the execution screen of the first application and determine the notification information as a first layer,
determine the execution screen of the first application as a second layer having a lower priority of display than the first layer,
generate a second frame by synthesizing the notification information determined as the first layer and the execution screen of the first application determined as the second layer together with the task bar, and display the second frame on the touch-sensitive display, and
based on a user input regarding the notification information being received through the touch-sensitive display, and an icon corresponding to the second application being configured to be provided through the task bar:
determine the execution screen of the second application as the first layer and configure the execution screen of the second application to be smaller than the size of the execution screen of the first application, and
generate a third frame by synthesizing the execution screen of the second application determined as the first layer and the execution screen of the first application determined as the second layer together with the task bar, and display the third frame on the touch-sensitive display.

2. The portable electronic device of claim 1, wherein the instructions, when executed by the at least one processor individually or collectively, further cause the portable electronic device to:
receive a conversation-related message from an external device through the wireless communication circuit, and
recognize the received conversation-related message as the notification information to be provided to a user.

3. The portable electronic device of claim 1, wherein the instructions, when executed by the at least one processor individually or collectively, further cause the portable electronic device to:
recognize a location of the portable electronic device by using the wireless communication circuit, and
determine a card-related message as the notification information, based on the recognized location and a time of stay at the location satisfying a designated condition.

4. The portable electronic device of claim 1, wherein the instructions, when executed by the at least one processor individually or collectively, further cause the portable electronic device to:
receive a streaming-related message from an external device through the wireless communication circuit, and
recognize the received streaming-related message as the notification information to be provided to a user.

5. The portable electronic device of claim 1, wherein the instructions, when executed by the at least one processor individually or collectively, further cause the portable electronic device to display an image related to the acquired message on the task bar instead of the icon while the notification information is displayed.

6. The portable electronic device of claim 1, wherein the instructions, when executed by the at least one processor individually or collectively, further cause the portable electronic device to configure the notification information, based on the icon being configured to be provided through the task bar, display an image related to the acquired message on the task bar instead of the icon, and display the notification information at a location adjacent to the task bar.

7. A portable electronic device comprising:
a touch-sensitive display;
a wireless communication circuit;
memory, comprising one or more storage media, storing instructions; and
at least one processor operatively connected to the touch-sensitive display, the wireless communication circuit, and the memory,
wherein the instructions, when executed by the at least one processor individually or collectively, cause the portable electronic device to:
display a home screen on the touch-sensitive display,
acquire notification information associated with an application through the wireless communication circuit,
configure the notification information to be smaller than a size of the home screen and determine the notification information as a first layer,
determine the home screen as a second layer having a lower priority of display than the first layer,
generate a first frame by synthesizing the notification information determined as the first layer and the home screen determined as the second layer, and display the first frame on the touch-sensitive display, and
based on a user input regarding the notification information being received through the touch-sensitive display, and an icon corresponding to the application being configured to be provided through the home screen:
determine an execution screen of the application as the first layer instead of the notification information, and configure the execution screen of the application to be smaller than the size of the home screen, and
generate a second frame by synthesizing the execution screen of the application determined as the first layer and the home screen determined as the second layer, and display the second frame on the touch-sensitive display.

8. The portable electronic device of claim 7, wherein the instructions, when executed by the at least one processor individually or collectively, further cause the portable electronic device to:
receive a conversation-related message from an external device through the wireless communication circuit, and
recognize the conversation-related received message as the notification information to be provided to a user.

9. The portable electronic device of claim 7, wherein the instructions, when executed by the at least one processor individually or collectively, further cause the portable electronic device to:
recognize a location of the portable electronic device by using the wireless communication circuit, and
determine a card-related message as the notification information, based on the recognized location and a time of stay at the location satisfying a designated condition.

10. The portable electronic device of claim 7, wherein the instructions, when executed by the at least one processor individually or collectively, further cause the portable electronic device to:
receive a streaming-related message from an external device through the wireless communication circuit, and
recognize the received streaming-related message as the notification information to be provided to a user.

11. The portable electronic device of claim 8, wherein the instructions, when executed by the at least one processors individually or collectively, further cause the portable electronic device to display an image related to a received message on a task bar instead of an icon while the notification information is displayed.

12. The portable electronic device of claim 11, wherein the instructions, when executed by the at least one processors individually or collectively, further cause the portable electronic device to end display of the image concurrently with ending of display of the notification information, and resume display of the icon.

13. A portable electronic device comprising:
a touch-sensitive display;
a wireless communication circuit;
memory, comprising one or more storage media, storing instructions; and
at least one processor operatively connected to the touch-sensitive display, the wireless communication circuit and the memory,
wherein the instructions, when executed by the at least one processor individually or collectively, cause the portable electronic device to:
display a task bar on a first layer or on a second layer having a lower priority of display than the first layer, and display a first execution screen of a first application on the second layer,
receive a first user input regarding an icon located on the task bar from the touch-sensitive display,
determine an execution screen of a second application corresponding to the icon as the second layer instead of the first execution screen, based on the first user input, configure a second execution screen of the first application to be smaller than a size of the execution screen of the second application, and determine the second execution screen of the first application as the first layer,
generate a first frame by synthesizing the second execution screen determined as the first layer and the execution screen of the second application determined as the second layer, and display the first frame on the touch-sensitive display,
receive a second user input regarding the second execution screen from the touch-sensitive display,
determine a third execution screen of the first application as the first layer instead of the second execution screen, based on the first user input, and configure the third execution screen of the first application to be smaller than the size of the execution screen of the second application, and
generate a second frame by synthesizing the third execution screen determined as the first layer and the execution screen of the second application determined as the second layer, and display the second frame on the touch-sensitive display.

14. The portable electronic device of claim 13, wherein the instructions, when executed by the at least one processor individually or collectively, further cause the portable electronic device to:
display a first playback screen of a media player for playing videos received from an external device through the wireless communication circuit, as the first execution screen,
display a message screen of a message application as the execution screen of the second application,
display a second playback screen having a smaller size than the message screen as the second execution screen, and
display video-related content as the third execution screen.

15. One or more non-transitory computer-readable storage media storing one or more computer programs including computer-executable instructions that, when executed by at least one processor of a portable electronic device individually or collectively, cause the portable electronic device to perform operations, the operations comprising:
generating, by the portable electronic device, a first frame by synthesizing a task bar and an execution screen of a first application, and display the first frame on a touch-sensitive display;
acquiring, by the portable electronic device, a message associated with a second application through a wireless communication circuit;
configuring, by the portable electronic device, notification information associated with the acquired message to be smaller than a size of the execution screen of the first application and determine the notification information as a first layer;
determining, by the portable electronic device, the execution screen of the first application as a second layer having a lower priority of display than the first layer;
generating, by the portable electronic device, a second frame by synthesizing the notification information determined as the first layer and the execution screen of the first application determined as the second layer together with the task bar, and display the second frame on the touch-sensitive display; and
based on a user input regarding the notification information being received through the touch-sensitive display, and an icon corresponding to the second application being configured to be provided through the task bar:
determining, by the portable electronic device, the execution screen of the second application as the first layer and configure the execution screen of the second application to be smaller than the size of the execution screen of the first application; and
generating, by the portable electronic device, a third frame by synthesizing the execution screen of the second application determined as the first layer and the execution screen of the first application determined as the second layer together with the task bar, and display the third frame on the touch-sensitive display.

16. The one or more non-transitory computer-readable storage media of claim 15, the operations further comprising:
receiving a conversation-related message from an external device through the wireless communication circuit; and
recognizing the received conversation-related message as the notification information to be provided to a user.

17. The one or more non-transitory computer-readable storage media of claim 15, the operations further comprising:
recognizing a location of the portable electronic device by using the wireless communication circuit; and
determining a card-related message as the notification information, based on the recognized location and a time of stay at the location satisfying a designated condition.

18. The one or more non-transitory computer-readable storage media of claim 15, the operations further comprising:
receiving a streaming-related message from an external device through the wireless communication circuit; and
recognizing the received streaming-related message as the notification information to be provided to a user.

19. The one or more non-transitory computer-readable storage media of claim 15, the operations further comprising displaying an image related to the acquired message on the task bar instead of the icon while the notification information is displayed.

20. A method performed by a portable electronic device with a touch sensitive display, the method comprising:
generating, by the portable electronic device, a first frame by synthesizing a task bar and an execution screen of a first application, and display the first frame on a touch-sensitive display;
acquiring, by the portable electronic device, a message associated with a second application through a wireless communication circuit;
configuring, by the portable electronic device, notification information associated with the acquired message to be smaller than a size of the execution screen of the first application and determine the notification information as a first layer;
determining, by the portable electronic device, the execution screen of the first application as a second layer having a lower priority of display than the first layer;
generating, by the portable electronic device, a second frame by synthesizing the notification information determined as the first layer and the execution screen of the first application determined as the second layer together with the task bar, and display the second frame on the touch-sensitive display; and
based on a user input regarding the notification information being received through the touch-sensitive display, and an icon corresponding to the second application being configured to be provided through the task bar:
determining, by the portable electronic device, the execution screen of the second application as the first layer and configure the execution screen of the second application to be smaller than the size of the execution screen of the first application; and
generating, by the portable electronic device, a third frame by synthesizing the execution screen of the second application determined as the first layer and the execution screen of the first application determined as the second layer together with the task bar, and display the third frame on the touch-sensitive display.
